(19) United States
(12) Patent Application Publication
(10) Pub. No.: US 2026/0353153 A1
(43) Pub. Date: Nov. 5, 2026

(54) METHOD FOR OBTAINING CHANNEL STATE INFORMATION REPORT, TERMINAL, AND NETWORK-SIDE DEVICE

(71) Applicant: VIVO MOBILE COMMUNICATION CO., LTD., Dongguan (CN)

(72) Inventors: Jiangwei YUAN, Dongguan (CN); Hao LIU, Dongguan (CN)

(21) Appl. No.: 19/660,671

(22) Filed: Apr. 28, 2026

Related U.S. Application Data
(63) Continuation of application No. PCT/CN2024/128932, filed on Oct. 31, 2024.

(30) Foreign Application Priority Data
Nov. 3, 2023 (CN) 202311467149.6

(51) Int. Cl. H04W 24/10

(52) U.S. Cl. CPC H04W 24/10

(57) ABSTRACT

A method for obtaining a channel state information report (CSI), a terminal, and a network side device are disclosed in the field of wireless communication technologies. The method for obtaining a channel state information report in embodiments of this application includes: determining, by a terminal, that a first CSI report to be fed back currently includes target information, where the target information includes at least one of the following: delay information or frequency offset information; and obtaining, by the terminal, the target information based on a reference signal associated with the first CSI report.

### CROSS-REFERENCE TO RELATED APPLICATIONS

This application is a bypass continuation application of International Application No. PCT/CN2024/128932, filed on Oct. 31, 2024, which claims the benefit of and priority to Chinese Patent Application No. 202311467149.6, filed on Nov. 3, 2023, and entitled “METHOD FOR OBTAINING CHANNEL STATE INFORMATION REPORT, TERMINAL, AND NETWORK SIDE DEVICE”, the contents of both of which being incorporated by reference in their entireties herein.

### TECHNICAL FIELD

This application relates to the field of wireless communication technologies and, in particular, to a method for obtaining a channel state information report, a terminal, and a network side device.

### BACKGROUND

In the related art a channel state information (CSI) report typically includes one or more of the following: a precoding matrix indicator (PMI), a channel quality indicator (CQI), a rank indicator (RI), a layer Indicator (LI), a CSI-RS resource indicator (CRI), a layer 1 reference signal received power (L1-RSRP), and a layer 1 signal-to-noise and interference ratio (L1-SINR).

### SUMMARY

According to a first aspect, a method for obtaining a channel state information report is provided, including: determining, by a terminal, that a first CSI report to be fed back currently includes target information, where the target information includes at least one of the following: delay information or frequency offset information; and obtaining, by the terminal, the target information based on a reference signal associated with the first CSI report.

According to a second aspect, a method for configuring a channel state information report is provided, including: sending, by a network side device, first network signaling to a terminal, where the first network signaling is used to configure a first CSI report fed back by the terminal to include target information, and the target information includes at least one of the following: delay information or frequency offset information.

According to a third aspect, an apparatus for obtaining a channel state information report is provided, including: a first determining module, configured to determine that a first CSI report to be fed back currently includes target information, where the target information includes at least one of the following: delay information or frequency offset information; and an obtaining module, configured to obtain the target information based on a reference signal associated with the first CSI report.

According to a fourth aspect, an apparatus for configuring a channel state information report is provided, including: a second determining module, configured to determine that a first CSI report fed back by a terminal includes target information, where the target information includes at least one of the following: delay information or frequency offset information; and a sending module, configured to send first network signaling to a terminal, where the first network signaling is used to configure a first CSI report fed back by the terminal to include the target information.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface, where the processor is configured to implement the steps of the method according to the first aspect when executing, and the communication interface is configured to be coupled to the processor.

According to a seventh aspect, a network side device is provided. The network side device includes a processor and a memory, and the memory stores a program or an instruction executable on the processor, where the program or the instruction is executed by the processor to implement the steps of the method according to the second aspect.

According to an eighth aspect, a network side device is provided, including a processor and a communication interface, where the processor is configured to implement the steps of the method according to the second aspect when executing, and the communication interface is configured to be coupled to the processor.

According to a ninth aspect, a readable storage medium is provided. The readable storage medium stores a program or an instruction, and when the program or the instruction is executed by a processor, the steps of the method according to the first aspect are implemented, or the steps of the method according to the second aspect are implemented.

According to a tenth aspect, a wireless communication system is provided, including a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the program/program product is executed by at least one processor to implement the steps of the method according to the first aspect or the steps of the method according to the second aspect.

### BRIEF DESCRIPTION OF DRAWINGS

FIG. 1 is a block diagram of a wireless communication system to which embodiments of this application may be applied;

FIG. 2 is a schematic flowchart of a method for obtaining a channel state information report according to an embodiment of this application;

FIG. 3 is a schematic diagram of a timing according to an embodiment of this application;

FIG. 4 is a schematic diagram of another timing sequence according to an embodiment of this application;

FIG. 5 is a schematic flowchart of a method for configuring a channel state information report according to an embodiment of this application;

FIG. 6 is a schematic diagram of a structure of an apparatus for obtaining a channel state information report according to an embodiment of this application;

FIG. 7 is a schematic diagram of a structure of an apparatus for configuring a channel state information report according to an embodiment of this application;

FIG. 8 is a schematic diagram of a structure of a communication device according to an embodiment of this application;

FIG. 9 is a schematic diagram of a hardware structure of a terminal according to an embodiment of this application; and

FIG. 10 is a schematic diagram of a hardware structure of a network side device according to an embodiment of this application.

### DETAILED DESCRIPTION

The following describes the technical solutions in the embodiments of this application with reference to the accompanying drawings in the embodiments of this application. Understandably, the described embodiments are some, but not all, of the embodiments of this application. All other embodiments obtained by a person of ordinary skill in the art based on the embodiments of this application shall fall within the protection scope of this application.

Terms, such as “first” and “second,” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in this application may be either a direct indication (or referred to as an explicit indication) or an indirect indication (or referred to as an implicit indication). The direct indication may be understood as that a sender clearly informs a receiver of specific information, an operation required to be performed, a request result, or the like in a sent indication; and the indirect indication may be understood as that the receiver determines corresponding information based on an indication sent by the sender, or makes a determination and determines the operation required to be performed, the request result, or the like based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are in most of the following descriptions, but these technologies can also be applied to a system other than the NR system, for example, a 6th generation (6G) communication system.

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), ship-borne equipment, pedestrian user equipment (PUE), smart household (household devices with wireless communication functions, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. As long as a same technical effect is achieved, the base station is not limited to a specified technical term. It should be noted that, in the embodiments of this application, only a base station in an NR system is used as an example for description, but a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), centralized network configuration (CNC), a network repository function (NRF), a network exposure function (NEF), a local NEF (Local NEF or L-NEF), a binding support function (BSF), an application function (AF), or the like. It should be noted that, in the embodiments of this application, only a core network device in an NR system is used as an example for description, and a specific type of the core network device is not limited.

To better understand the technical solutions provided in this application, related art involved in this application is described first.

### 1. CSI Architecture

Generally, the CSI architecture can be divided into two parts: downlink CSI and uplink CSI. Downlink CSI architecture: including a downlink physical channel and a downlink reference signal; and uplink CSI architecture: including an uplink physical channel and an uplink reference signal.

Generally, the downlink physical channel is used for data transmission, and the downlink reference signal is used for channel estimation, to obtain downlink channel state information (CSI). Generally, the uplink physical channel is used for uplink data transmission, and the uplink reference signal is used for channel estimation, to obtain uplink channel state information (CSI).

In the 5G system, the CSI is mainly used for adaptive beamforming (ABF) and multiple-input multiple-output (MIMO) technologies, to improve wireless transmission bandwidth and reliability.

Generally, the CSI architecture of 5G is a very important technology in the 5G communication system, and plays an important role in improving wireless transmission bandwidth and reliability, interference coordination, and other aspects.

### 2. CSI Report Content

Generally, the terminal may determine, by using higher layer signaling or default rules, that the CSI report may include one of the following: ‘none’, ‘cri-ri-pmi-cqi’, ‘cri-RI-i1’, ‘cri-RI-CQI’, ‘cri-RSRP’, ‘cri-SINR’, ‘ssb-Index-RSRP’, ‘ssb-Index-SINR’, or ‘cri-RI-LI-PMI-CQI’.

If the terminal is configured with CSI-ReportConfig, and an upper layer parameter reportQuantity is set to “none”, the terminal may not report anything for CSI-ReportConfig.

### 3. CSI Obtaining

For each CSI report configuration (CSI-ReportConfig), the network associates a reference signal resource configuration (CSI-ResourceConfig) for channel measurement, and a reference signal resource configuration for interference measurement associated with a CSI-IM (CSI interference measurement) resource, and/or a reference signal resource configuration for interference measurement associated with an NZP-CSI RS (non-zero power CSI-RS) resource. The terminal obtains corresponding channel information by measuring the reference resources associated with these resource configurations, where currently, the corresponding channel information may usually be considered as baseband digital precoding matrix information and baseband modulation mode recommendation information, further obtains corresponding CSI information based on codebook configuration information and report content associated with the CSI report configuration, and performs feedback based on an uplink channel.

For feedback of a PMI, if it is Rel-15 Type1 codebook configuration, the terminal measures a maximum of eight channel measurement reference signals, and selects one of them to feed back the PMI. If it is a Rel-15 Type2/Rel-16 Type2/Rel-17 codebook, the terminal measures one channel measurement reference signal, and feeds back a PMI associated with the reference signal. If it is a Rel-18 Type2 coherent joint transmission (CJT) codebook, the terminal measures a maximum of four reference signals, assumes that the four reference signals are associated with four TRPs, and obtains and feeds back a PMI by using channels associated with the four reference signals. If it is a Rel-18 Type2 prediction codebook, for a periodic/semi-persistent channel measurement reference signal, the network side device configures one reference signal, and the terminal obtains a predicted PMI by using a plurality of sending moments of one reference signal; and for an aperiodic channel measurement reference signal, the network side device configures a maximum of 12 reference signals, the 12 reference signals are sent at intervals in time, and the terminal obtains the predicted PMI by using one of sending moments of the 12 reference signals.

In addition, if it is to obtain CJT CSI, a delay offset that is between two TRPs and that the terminal can feed back is 1/B*N3, where B is a CSI reference signal bandwidth, and N3 is a quantity of PMI subbands. It indicates that if the delay offset between the two TRPs exceeds this range, performance of the terminal in obtaining the PMI may decline. In other words, the network side device cannot obtain the delay offset between the two TRPs by using the PMI.

CSI associated with the Rel-15 Type2/Rel-16 Type2/Rel-17 codebook may be divided into two parts, namely, Part1 and Part2. The two parts are coded independently, and by interpreting content of Part1 of a CSI report, the network side device may determine a size of Part2 of the CSI report.

However, there is no CSI report feedback framework in the related art to support the terminal in assisting the network side device in time synchronization, timing synchronization, or frequency alignment. That is, a terminal cannot assist a network side device in time synchronization or frequency alignment. To solve this problem, the embodiments of this application provide a method for obtaining a channel state information report, a terminal, and a network side device, which can solve the problem that a terminal cannot assist a network side device in time synchronization or frequency alignment.

The following describes in detail the method for obtaining a channel state information report provided in the embodiments of this application through some embodiments and application scenarios thereof with reference to the accompanying drawings.

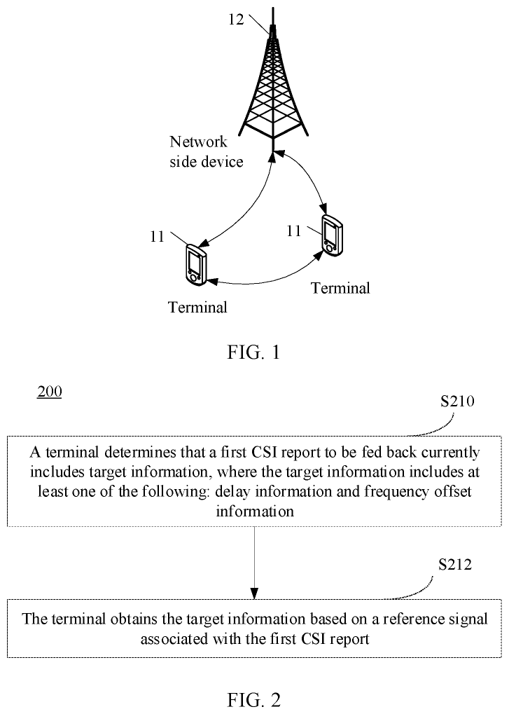

FIG. 2 is a schematic flowchart of a method for obtaining a channel state information report according to an embodiment of this application. The method 200 may be performed by a terminal. In other words, the method may be performed by software or hardware installed in the terminal. As shown in FIG. 2, the method may include the following steps.

S210: A terminal determines that a first CSI report to be fed back currently includes target information, where the target information includes at least one of the following: delay information or frequency offset information.

In this embodiment of this application, the terminal may determine, based on network signaling of a network side device or based on measurement of a reference signal, that the first CSI report to be fed back currently includes the target information, that is, includes at least one of the delay information or the frequency offset information.

In an optional implementation, the determining, by a terminal, that a first channel state information (CSI) report to be fed back currently includes target information includes: determining, by the terminal based on first network signaling sent by a network side device, that the first CSI report includes the target information.

In the above implementation, the terminal may receive signaling sent by the network side device, which may be network signaling, for example, radio resource control (RRC) signaling, medium access control control element (MACCE), or downlink control information (DCI), determine that the first CSI report includes one or two types of information in delay information and frequency offset information, and feed back the first CSI report to the network side device by using an uplink channel resource subsequently, which facilitates synchronization or frequency alignment between the network side device and the terminal, to achieve better transmission performance or transmission performance of a multi-transmission and reception point (MTRP) subsequently. Optionally, the terminal determines, based on the network signaling or the DCI sent by the network side device, that the first CSI report includes one of the following: delay information, frequency offset information, or delay information and frequency offset information, that is, the network side device may configure, by using network signaling, the first CSI report fed back by the terminal to include delay information, frequency offset information, or delay information and frequency offset information, or may indicate, by using the DCI, to the terminal that the first CSI report fed back by the terminal includes delay information, frequency offset information, or delay information and frequency offset information. In this way, the network side device may flexibly adjust content in the CSI report based on known information or channel reciprocity, to avoid feedback of some useless information.

In another optional implementation, the determining, by a terminal, that a first channel state information (CSI) report to be fed back currently includes target information includes: determining, by the terminal based on measurement of a reference signal, that the first CSI report includes the target information. In the above implementation, the terminal may receive the reference signal sent by the network side device, and determine that the first CSI report includes one or two types of information in delay information and frequency offset information. Further, optionally, the terminal may receive the reference signal sent by the network side device, and determine a reference signal associated with the delay information or the frequency offset information in the first CSI report, which may also be understood as that the terminal determines which reference signals need to be fed back with delay information or frequency offset information.

In an optional implementation, the method may further include at least one of the following.

(1) The terminal determines, based on second network signaling sent by a network side device, at least one first reference signal or at least one first reference signal set associated with the delay information, where the first reference signal set includes at least one first reference signal. (2) The terminal determines, based on third network signaling sent by a network side device, at least one second reference signal or at least one second reference signal set associated with the frequency offset information, where the second reference signal set includes at least one second reference signal.

In an optional implementation of this embodiment of this application, the network side device may control content and a size of the CSI report by indicating a reference signal or a reference signal set to the terminal, thereby avoiding feedback of some useless information and reducing network signaling overheads. It may be understood that the network side device may indicate some reference signals or reference signal sets in a plurality of reference signals or reference signal sets to obtain delay information or frequency offset information.

For the reference signal or the reference signal set determined to obtain the delay information or the frequency offset information, on the one hand, the terminal may determine, based on the network signaling, the reference signal or the reference signal set for obtaining the delay information, or the terminal may determine, based on the network signaling, the reference signal or the reference signal set for obtaining the frequency offset information. In other words, the network side device may indicate that the reference signal or the reference signal set associated with the delay information and the reference signal or the reference signal set associated with the frequency offset information are not exactly the same. In this way, the network side device may flexibly and independently configure or indicate, to the terminal, the reference signal or the reference signal set associated with the delay information and the reference signal or the reference signal set associated with the frequency offset information. For example, a CSI report configuration is associated with four reference signal sets to obtain the delay information and the frequency offset information. By using network signaling, the terminal determines that the reference signal set for obtaining the delay information is set 0/1/2, and the reference signal set for obtaining the frequency offset information is set 1/2/3.

On the other hand, the terminal may determine, based on the network signaling, the reference signal or the reference signal set for obtaining the delay information and the frequency offset information, that is, the delay information and the frequency offset information share a same reference signal or reference signal set. For example, a CSI report configuration is associated with four reference signal sets, and the network side device indicates, by using network signaling, that the reference signal set used by the terminal to obtain the delay information and the frequency offset information is set 0/1/2.

In this way, the network side device may flexibly control a quantity of pieces of delay information or frequency offset information fed back by the terminal, and may also avoid a waste of resources caused when the terminal feeds back known information of the network side device.

(3) The terminal determines, based on fourth network signaling sent by a network side device, an accuracy of the delay information.

(4) The terminal determines, based on fifth network signaling sent by a network side device, an accuracy of the frequency offset information.

In an optional implementation of this embodiment of this application, the network side device may further indicate a granularity of the delay information or the frequency offset information to the terminal by using network signaling, that is, the network side device may control an accuracy or a unit of the delay information and/or the frequency offset information fed back by the terminal, to avoid feeding back a large delay or frequency offset with a high accuracy, and feeding back a small delay or frequency offset with a low accuracy, thereby effectively utilizing feedback resources and improving effectiveness of feedback information.

A method for effectively utilizing feedback resources is that the accuracy is indicated by the terminal to the network, that is, the terminal may select, based on delay information and frequency offset information obtained by the terminal, a proper time unit or frequency offset unit to feed back the delay information and/or the frequency offset information. In this way, the network side device may indicate a total feedback overhead to the terminal, and the terminal may feed back the delay information and/or the frequency offset information with a highest accuracy without exceeding the total feedback overhead.

The accuracy of the delay information may refer to a length of a time unit, such as 1 ms or 1 Ts (sampling period). The accuracy of the frequency offset information may refer to a size of a frequency offset unit, for example, 1 Hz, 1000 Hz, 1/N (N is fft size), or K times of Pi (K is a rational number).

Alternatively, the network side device may indicate a plurality of time units or frequency offset units to the terminal, and the terminal selects a proper time unit or frequency offset unit to feed back corresponding delay information or frequency offset information.

(5) The terminal determines, based on sixth network signaling sent by a network side device, a quantity of pieces of delay information included in the first CSI report.

(6) The terminal determines, based on seventh network signaling sent by a network side device, a maximum quantity of pieces of delay information included in the first CSI report.

(7) The terminal determines, based on eighth network signaling sent by a network side device, a quantity of pieces of frequency offset information included in the first CSI report.

(8) The terminal determines, based on ninth network signaling sent by a network side device, a maximum quantity of pieces of frequency offset information included in the first CSI report.

It should be noted that the first to ninth network signaling may be one network signaling or a plurality of network signaling, and any two, three, four, five, six, seven, eight, or nine of the first to ninth network signaling may be the same network signaling.

In an optional implementation of this embodiment of this application, the network side device may further indicate, to the terminal by using network signaling, the quantity of pieces of delay information included in the CSI report, and the terminal may select, based on the determined quantity of pieces of delay information, a proper reference signal or reference signal set to feed back delay information associated with the terminal. In this case, a part of delay information fed back by the terminal may be invalid or specific, indicating that the delay information associated with a corresponding reference signal or reference signal set exceeds an available range.

Alternatively, the network side device may further indicate, to the terminal by using network signaling, the maximum quantity of pieces of delay information included in the CSI report, and the terminal selects a proper reference signal or reference signal set to feed back delay information associated with the terminal. Further, the quantity of pieces of delay information does not exceed the maximum quantity. Optionally, the quantity or the maximum quantity of pieces of frequency offset information included in the first CSI report may also be indicated to the terminal in a similar manner as described above. Optionally, a quantity or a maximum quantity of frequency offset information-delay information pairs included in the first CSI report may also be indicated to the terminal by using the network signaling. In these manners, quality of the delay information or the frequency offset information in the CSI report may be effectively improved, and feedback of too many values exceeding a processing range may be avoided.

In an optional implementation, in a case that the first CSI report includes the frequency offset information, the frequency offset information included in the first CSI report includes one of the following.

(1) A frequency offset associated with each second reference signal, that is, each piece of frequency offset information included in the first CSI report is the frequency offset of each second reference signal. Optionally, the quantity of pieces of frequency offset information may be a quantity of second reference signals associated with the first CSI report, the quantity of pieces of frequency offset information is a quantity of second reference signals indicated by the network side device, or the quantity of pieces of frequency offset information is a quantity of second reference signals selected by the terminal. (2) A frequency offset associated with each second reference signal set, that is, each piece of frequency offset information included in the first CSI report is the frequency offset of each second reference signal set.

Optionally, in a case that the first CSI report includes the frequency offset information, and the frequency offset information is each second reference signal, the quantity of pieces of frequency offset information in the first CSI report may be the quantity of second reference signal sets associated with the first CSI report, the quantity of pieces of frequency offset information is the quantity of second reference signal sets indicated by the network side device, or the quantity of pieces of frequency offset information is the quantity of second reference signal sets selected by the terminal.

Optionally, in a case that the frequency offset information included in the first CSI report is the frequency offset associated with each second reference signal or the frequency offset associated with each second reference signal set, the terminal determines or assumes that a reference signal associated with the first CSI report or a physical downlink channel associated with the first CSI report has no frequency offset, or the terminal determines that a reference signal associated with the first CSI report or a physical downlink channel associated with the first CSI report has no offset value of the frequency offset. For example, when receiving the reference signal associated with the first CSI report or the physical downlink channel associated with the first CSI report, the terminal receives or demodulates the reference signal associated with the first CSI report or the physical downlink channel associated with the first CSI report in a case of assuming that there is no frequency offset or no offset value of the frequency offset.

(3) An offset value of a frequency offset of each second reference signal relative to a frequency offset associated with a benchmark reference signal, that is, in this optional implementation, each of a plurality of pieces of frequency offset information included in the first CSI report is an offset value of a frequency offset of a second reference signal relative to the benchmark reference signal. In this embodiment of this application, the benchmark reference signal refers to a reference signal used as a benchmark, and a frequency offset of the benchmark reference signal is used as a benchmark. That is, an offset value of the frequency offset of the benchmark reference signal is set to 0, and an offset value of a frequency offset of each of other second reference signals relative to the frequency offset of the benchmark reference signal is obtained.

Optionally, in a case that the first CSI report includes the frequency offset information, and the frequency offset information is the offset value of the frequency offset of each second reference signal relative to the frequency offset associated with the benchmark reference signal, the quantity of pieces of frequency offset information in the first CSI report may be reduced by 1 from a total quantity of second reference signals associated with the first CSI report, or reduced by 1 from a total quantity of second reference signals indicated by the network side device, or reduced by 1 from a total quantity of second reference signals selected by the terminal. That is, the benchmark reference signal may be one of the plurality of second reference signals associated with the first CSI report, or one of the plurality of second reference signals indicated by the network side device, or one of the plurality of second reference signals selected by the terminal.

Optionally, in a case that the first CSI report includes the frequency offset information, and the frequency offset information is the offset value of the frequency offset of each second reference signal relative to the frequency offset associated with the benchmark reference signal, the quantity of pieces of frequency offset information in the first CSI report may alternatively be reduced by N from the total quantity of second reference signals associated with the first CSI report, or reduced by N from the total quantity of second reference signals indicated by the network side device, or reduced by N from the total quantity of second reference signals selected by the terminal, where N is an integer greater than 1. That is, the benchmark reference signal may be N of the plurality of second reference signals associated with the first CSI report, for example, first N or last N, or N of the plurality of second reference signals indicated by the network side device, or N of the plurality of second reference signals selected or indicated by the terminal.

(4) An offset value of a frequency offset of each second reference signal set relative to a frequency offset associated with a benchmark reference signal set. That is, in this optional implementation, each of the plurality of pieces of frequency offset information included in the first CSI report is an offset value of a frequency offset of a second reference signal set relative to the benchmark reference signal set. In this embodiment of this application, the benchmark reference signal set refers to a reference signal set used as a benchmark, and a frequency offset of the benchmark reference signal set is used as a benchmark. That is, an offset value of the frequency offset of the benchmark reference signal set is set to 0, and an offset value of a frequency offset of each of other second reference signal sets relative to the frequency offset of the benchmark reference signal set is obtained.

Optionally, in a case that the first CSI report includes the frequency offset information, and the frequency offset information is the offset value of the frequency offset of each second reference signal set relative to the frequency offset associated with the benchmark reference signal set, the quantity of pieces of frequency offset information in the first CSI report may be reduced by 1 from a total quantity of second reference signal sets associated with the first CSI report, or reduced by 1 from a total quantity of second reference signal sets indicated by the network side device, or reduced by 1 from a total quantity of second reference signal sets selected by the terminal. That is, the benchmark reference signal set may be one of the plurality of second reference signal sets associated with the first CSI report, or one of the plurality of second reference signal sets indicated by the network side device, or one of the plurality of second reference signal sets selected by the terminal.

Optionally, in a case that the first CSI report includes the frequency offset information, and the frequency offset information is the offset value of the frequency offset of each second reference signal set relative to the frequency offset associated with the benchmark reference signal set, the quantity of pieces of frequency offset information in the first CSI report may alternatively be reduced by N from the total quantity of second reference signal sets associated with the first CSI report, or reduced by N from the total quantity of second reference signal sets indicated by the network side device, or reduced by N from the total quantity of second reference signal sets selected by the terminal, where N is an integer greater than 1. That is, the benchmark reference signal set may be N of the plurality of second reference signal sets associated with the first CSI report, for example, first N or last N, or N of the plurality of second reference signal sets indicated by the network side device, or N of the plurality of second reference signal sets selected or indicated by the terminal.

In an optional implementation of this embodiment of this application, when the first CSI report includes frequency offset information, one piece of frequency offset information may be a frequency offset associated with one second reference signal or second reference signal set, or an offset value of a frequency offset associated with two second reference signals or second reference signal sets. For example, in an MTRP scenario, it may be understood that the terminal feeds back a frequency offset for each TRP, or the terminal determines a reference TRP and feeds back an offset value of a frequency offset of another TRP relative to the reference TRP.

For a case in which one piece of frequency offset information may be a frequency offset associated with a reference signal or a reference signal set, in an implementation, the quantity of pieces of frequency offset information may be the quantity of second reference signal sets or second reference signals associated with the first CSI report. In another implementation, the quantity of pieces of frequency offset information may be the quantity of second reference signal sets or the quantity of second reference signals indicated by the network side device. In still another implementation, the quantity of pieces of frequency offset information may be the quantity of second reference signal sets or the quantity of second reference signals selected by the terminal.

Optionally, when the frequency offset information is a frequency offset, the reference signal or the physical downlink channel associated with the first CSI report does not consider a frequency offset or impact of a frequency offset. It may be understood that the terminal has fed back the frequency offset to the network side device, and the network side device compensates based on the frequency offset. The terminal may assume that there is no frequency offset to deal with subsequent impact of the frequency offset. In this case, if there is a quasi-co-location information configuration, for quasi-co-location information associated with a channel measurement reference signal or a physical downlink channel, the terminal does not refer to a frequency offset in the quasi-co-location information, or the terminal assumes that there is no frequency offset. Alternatively, in this case, the channel measurement reference signal or the physical downlink channel is not associated with quasi-co-location information or associated with only spatial quasi-co-location information.

Similarly, when the CSI report includes the delay information, one piece of delay information may be a delay associated with one first reference signal or first reference signal set, or a delay offset associated with two first reference signals or first reference signal sets. For example, in an MTRP scenario, it may be understood that the terminal feeds back a delay for each TRP, or the terminal determines a reference TRP and feeds back a delay offset of another TRP relative to the reference TRP.

In a case that one piece of delay information may be a delay associated with a first reference signal or a first reference signal set, the quantity of pieces of delay information is the quantity of first reference signal sets or first reference signals associated with the first CSI report, or the quantity of pieces of delay information is the quantity of first reference signal sets or first reference signals indicated by the network side device, or the quantity of pieces of delay information is the quantity of first reference signal sets or first reference signals selected by the terminal.

For a case in which one piece of delay information may be a delay offset, that is, in this optional implementation, each of the plurality of pieces of delay information included in the first CSI report is a delay offset of a second reference signal or a second reference signal set relative to the benchmark reference signal or the benchmark reference signal set. Optionally, the quantity of pieces of delay information in the first CSI report may be reduced by 1 from a total quantity of first reference signals or first reference signal sets associated with the first CSI report, or reduced by 1 from a total quantity of first reference signals or first reference signal sets indicated by the network side device, or reduced by 1 from a total quantity of first reference signals or first reference signal sets selected by the terminal. That is, the benchmark reference signal or the benchmark reference signal set may be one of the plurality of first reference signals or first reference signal sets associated with the first CSI report, or one of the plurality of first reference signals or first reference signal sets indicated by the network side device, or one of the plurality of first reference signals or first reference signal sets selected by the terminal. Optionally, the quantity of pieces of frequency offset information in the first CSI report may be reduced by N from the total quantity of first reference signals or first reference signal sets associated with the first CSI report, or reduced by N from the total quantity of first reference signals or first reference signal sets indicated by the network side device, or reduced by N from the total quantity of first reference signals or first reference signal sets selected by the terminal, where N is an integer greater than 1. That is, the benchmark reference signal or the benchmark reference signal set may be N of the plurality of first reference signals or first reference signal sets associated with the first CSI report, for example, first N or last N, or N of the plurality of first reference signals or first reference signal sets indicated by the network side device, or N of the plurality of first reference signals or first reference signal sets selected or indicated by the terminal.

Optionally, when the delay information is a delay, the reference signal or the physical downlink channel associated with the first CSI report does not consider a delay or impact of a delay. It may be understood that the terminal has fed back the delay to the network side device, and the network side device compensates based on the delay. The terminal may assume that there is no delay to deal with subsequent impact of the delay. In this case, if there is a quasi-co-location information configuration, for quasi-co-location information associated with a channel measurement reference signal or a physical downlink channel, the terminal does not refer to a delay in the quasi-co-location information, or the terminal assumes that there is no delay. Alternatively, in this case, the channel measurement reference signal or the physical downlink channel is not associated with quasi-co-location information or associated with only spatial quasi-co-location information.

In an optional implementation, the terminal may determine, based on tenth network signaling sent by the network side device, that the frequency offset information includes the frequency offset or the offset value of the frequency offset, or determine that the delay information includes the delay or the delay offset. It may be understood that the network may configure, by using higher layer signaling, whether the terminal feeds back a frequency offset or a delay, or an offset value of a frequency offset or a delay offset.

S212: The terminal obtains the target information based on a reference signal associated with the first CSI report.

In this embodiment of this application, the terminal may obtain the target information based on the reference signal associated with the first CSI report. For example, the terminal may obtain delay information based on at least one first reference signal or at least one first reference signal set associated with the first CSI report, or the terminal may obtain frequency offset information based on at least one second reference signal or at least one second reference signal set associated with the first CSI report. The at least one first reference signal, the at least one first reference signal set, the at least one second reference signal, or the at least one second reference signal set associated with the first CSI report may be determined based on the reference signal or the reference signal set configured by the network side device, or indicated by the network side device by using network signaling, or selected by the terminal based on a measurement result, which may be determined based on an actual situation.

It should be noted that the at least one first reference signal and the at least one second reference signal may be one reference signal or a plurality of reference signals, or the at least one first reference signal set and the at least one second reference signal set may be one reference signal set or a plurality of reference signal sets.

In an optional implementation, when the terminal obtains the target information in the first CSI report, a quantity of CSI processing units (CPU) associated with the first CSI report is related to at least one of the following:
(1) a quantity of reference signal sets associated with the first CSI report; or
(2) the target information included in the first CSI report.

That is, for calculation of the first CSI report, the quantity of CPUs associated with the first CSI report is related to the quantity of reference signal sets associated with the first CSI report; or for calculation of the first CSI report, the quantity of CPUs associated with the first CSI report is related to whether report content associated with the first CSI report is one or two of the delay information or the frequency offset information.

In another optional implementation, for calculation of the first CSI report, the quantity of CPUs associated with the first CSI report is related to the quantity of at least one first reference signal or at least one first reference signal set associated with the first CSI report; or for calculation of the first CSI report, the quantity of CPUs associated with the first CSI report is related to the quantity of at least one second reference signal or at least one second reference signal set associated with the first CSI report.

In an optional implementation, in a case that the target information included in the first CSI report is a delay offset or an offset value of a frequency offset, the method may further include: carrying, by the terminal, target indication information in the first CSI report, where the target indication information indicates a reference signal or a reference signal set referenced by the target information.

In the above optional implementation, when the frequency offset information included in the first CSI report is the offset value of the frequency offset, or the delay information included in the first CSI report is the delay offset, a reference frequency offset or a reference delay of the offset may be indicated by the terminal. Optionally, the terminal may indicate, to the network side device in the first CSI report, that a reference signal or a reference signal set is a reference of an offset value of the frequency offset and the delay offset; or the terminal may indicate, to the network side device in the first CSI report, that a reference signal or a reference signal set is a reference of an offset value of the frequency offset; or the terminal may indicate, to the network side device in the first CSI report, that a reference signal or a reference signal set is a reference of the delay offset.

In an optional implementation, after S212, the method may further include: feeding back, by the terminal, the first CSI report, where a feedback priority of the first CSI report is higher than that of a second CSI report, and the second CSI report includes multi-transmission and reception point (MTRP) CSI. The feedback priority of the first CSI report is higher than that of the second CSI report, which indicates that when the first CSI report conflicts with the second CSI report, or the first CSI report and the second CSI report are multiplexed into a same channel resource (for example, PUSCH/PUCCH), the first CSI report is preferentially processed or fed back.

Optionally, it may be determined that the feedback priority of the first CSI report is higher than that of the second CSI report when the first CSI report and the second CSI report meet at least one of the following requirements:
(1) the first CSI report and the second CSI report are associated with a same CSI report type, where the CSI report type includes one of the following: a periodic CSI report, a semi-persistent CSI report, and an aperiodic CSI report;
(2) the first CSI report and the second CSI report are associated with a same channel type, where the channel type includes one of the following: a physical uplink shared channel (PUSCH) and a physical uplink control channel (PUCCH);
(3) the first CSI report and the second CSI report are associated with a same serving cell; or
(4) the first CSI report and the second CSI report have a target association relationship, where the target association relationship includes at least one of the following:
   (a) a quasi-co-location reference signal of a reference signal existing in reference signals associated with the second CSI report is the reference signal associated with the first CSI report;
   (b) an association relationship that is between the second CSI report and the first CSI report and that is indicated by eleventh network signaling associated with the second CSI report, where the eleventh network signaling includes one of the following: CSI report configuration signaling and serving cell configuration signaling. For example, a CSI report configuration (CSI-ReportConfig) command associated with the second CSI report establishes a target association relationship between the first CSI report and the second CSI report, or serving cell configuration (ServingCellConfig) signaling associated with the second CSI report establishes a target association relationship between the first CSI report and the second CSI report;
   (c) an association relationship that is between the second CSI report and the first CSI report and that is established by using a physical cell identifier; or
   (d) an association relationship that is between the second CSI report and the first CSI report and that is established by using a measurement bandwidth part.

In an actual system, there may a case in which a plurality of CSI reports conflict or a plurality of CSI reports are multiplexed into one channel resource (for example, multiplexed into one PUSCH). Therefore, priority orders of a plurality of types of CSI reports may be specified, and a CSI report with a higher priority may be preferentially processed or preferentially mapped onto the channel resource for feedback. Based on this, at least one first CSI report and at least one second CSI report may conflict or be multiplexed, which may also be understood as a case in which a CSI report carrying delay information and/or frequency offset information and an MTRP CSI report (the MTRP CSI report is usually a CSI report associated with joint measurement of a plurality of reference signals) conflict or are multiplexed.

In an implementation of this embodiment of this application, a priority of the first CSI report carrying delay information or frequency offset information is higher than that of the second CSI report (namely, the MTRP CSI report), because the delay information or the frequency offset information is more important to help the network side device achieve higher quality MTRP transmission. In addition, feedback of the delay information or the frequency offset information may not be as frequent as that of the MTRP CSI report. The MTRP CSI report is a CSI report in which the CSI report includes MTRP CSI (for example, CJT CSI, NCJT CSI, or dynamic point selection (DPS) CSI).

Further, optionally, a more detailed case may be established to help the terminal determine, more effectively and reasonably, a priority of a CSI report carrying delay information or frequency offset information. That is, the priority associated with the first CSI report is higher than that of the second CSI report when at least one of the following cases is satisfied. The cases include:
i. the first CSI report carrying delay information or frequency offset information and the MTRP CSI report are associated with a same CSI report type (a periodic CSI report, a semi-persistent CSI report, and an aperiodic CSI report);
ii. the first CSI report carrying delay information or frequency offset information and the MTRP CSI report are associated with a same channel type (PUSCH/PUCCH);
iii. the first CSI report carrying delay information or frequency offset information and the MTRP CSI report are associated with a same serving cell; or
iv. the first CSI report carrying delay information or frequency offset information and the MTRP CSI report have an association relationship.

In particular, the association relationship between the first CSI report carrying delay information or frequency offset information and the MTRP CSI report may be established in at least one of the following manners:
(a) a quasi-co-location reference signal of a reference signal existing in reference signals associated with the MTRP CSI report is a reference signal associated with the CSI report carrying delay information and/or frequency offset information;
(b) the association relationship is established by using network signaling associated with the MTRP CSI report (a CSI report configuration CSI-ReportConfig). For example, there is a parameter that is in the CSI-ReportConfig configuration and that is associated with the first CSI report carrying the delay information or the frequency offset information;
(c) the association relationship is established by using network signaling associated with the MTRP CSI report (a serving cell configuration ServingCellConfig). For example, the MTRP CSI report and the first CSI report carrying delay information or frequency offset information are associated with same network signaling, such as ServingCellConfig or CSI-MeasConfig;
(d) the association relationship is established by using a physical cell ID. For example, the MTRP CSI report and the first CSI report carrying delay information or frequency offset information are associated with a same physical cell ID; or
(e) the association relationship is established by using a measurement bandwidth part. For example, the MTRP CSI report and the first CSI report carrying delay information or frequency offset information are associated with a same measurement bandwidth.

In the above manner, priorities of the MTRP CSI report and the first CSI report carrying delay information or frequency offset information may be defined, to avoid inconsistent understanding between the terminal and the network side device in the priority of the CSI report, which leads to an error in parsing the CSI report by the network side device. In addition, more important CSI information may be preferentially fed back to the network side device as much as possible, thereby ensuring transmission stability.

In an optional implementation, the method may further include: determining, by the terminal in a first case, to feed back the first CSI report and perform a first target operation.

The first case may include at least one of the following. po (1) A latest transmission occasion of each reference signal associated with the first CSI report is later than a CSI reference resource associated with the second CSI report and earlier than a feedback slot or a feedback symbol associated with the second CSI report, and the second CSI report includes the MTRP CSI.

Optionally, the CSI reference resource may be an uplink slot, and may be associated with a downlink slot, a symbol of an uplink slot, or a symbol of a downlink slot. The terminal obtains CSI in the second CSI report based on the CSI reference resource.

Optionally, the feedback slot or the feedback symbol may be a 1^{st} slot or a 1^{st} symbol among all slots or symbols associated with the second CSI report, or may be a slot or a symbol specified in a protocol.

(2) A latest transmission occasion of any reference signal associated with the first CSI report is later than a CSI reference resource associated with the second CSI report and earlier than a feedback slot or a feedback symbol associated with the second CSI report.

(3) A feedback slot or a feedback symbol associated with the first CSI report is later than a CSI reference resource associated with the second CSI report and earlier than a feedback slot or a feedback symbol associated with the second CSI report.

The first target operation includes at least one of the following:
(a) skipping feeding back the second CSI report;
(b) feeding back a part of content of the second CSI report, for example, feeding back only CSI report part1 of the second CSI report, that is, Part1, or feeding back only STRP CSI in the second CSI report, and skipping feeding back MTRP CSI in the CSI report;
(c) indicating, in the first CSI report, whether to feed back the second CSI report; or
(d) indicating, in the first CSI report, whether to feed back a part of content of the second CSI report.

For example, after obtaining a configuration of the reference signal associated with the first CSI report, or after obtaining the reference signal associated with the first CSI report, or after obtaining the target information based on the reference signal associated with the first CSI report, the terminal may determine whether the first case is satisfied. If the first case is satisfied, the terminal determines to feed back the first CSI report, and the terminal does not feed back the second CSI report, or the terminal feeds back only a part of content of the second CSI report, or the terminal indicates, in the first CSI report, whether to feed back the second CSI report or the part of content of the second CSI report.

The latest transmission occasion includes but is not limited to one of the following: a latest transmission occasion of a reference signal earlier than a CSI reference resource associated with the first CSI report, a latest transmission occasion of a reference signal earlier than a feedback slot or a feedback symbol associated with the first CSI report, and a latest transmission occasion of a reference signal earlier than a slot or a symbol specified in a protocol associated with the first CSI report.

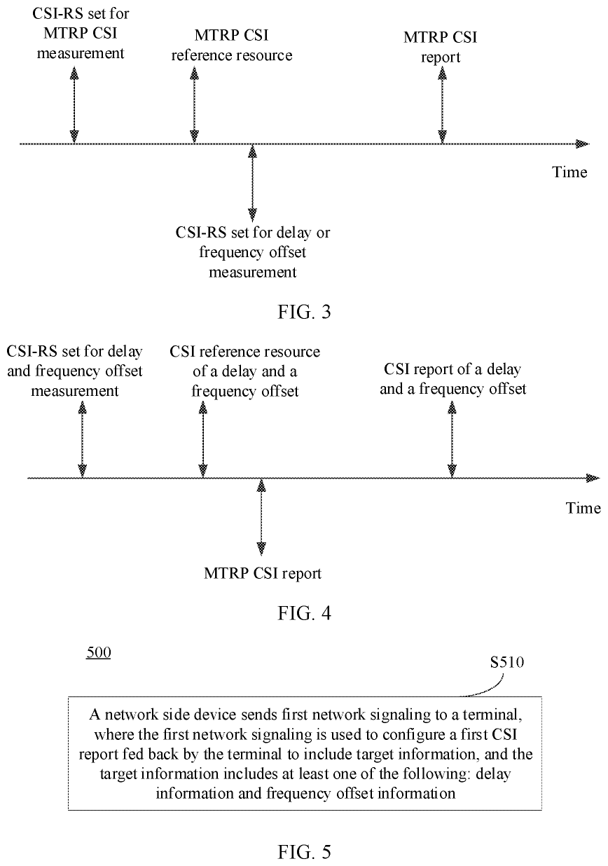

Because the CSI of the delay information or the frequency offset information may affect calculation of the MTRP CSI, there are some cases in which a CSI feedback of the delay information or the frequency offset information may lead to invalidation or inaccuracy of the MTRP CSI, resulting in performance loss. For example, in FIG. 3, when a reference signal of CSI used for obtaining the delay information or the frequency offset information appears between a CSI reference resource associated with the MTRP CSI and the CSI feedback, there may be a case in which the MTRP CSI is inaccurate or has a large error, because the MTRP CSI is calculated based on delay information and/or frequency offset information measured before the CSI reference resource, rather than being calculated based on a measurement result of latest measured delay information and/or frequency offset information.

For the above case, at least one of the following cases may be included.

(1) A latest transmission occasion of each reference signal associated with the first CSI report associated with the delay information or the frequency offset information is later than the CSI reference resource associated with the MTRP CSI report and earlier than the feedback slot or the feedback symbol associated with the MTRP CSI report, as shown in FIG. 3.

For example, when a receiving moment of each reference signal used by the terminal to obtain the first CSI report of the delay information or the frequency offset information is later than the CSI reference resource associated with the MTRP CSI report and earlier than the feedback slot or the feedback symbol associated with the MTRP CSI report, the CSI feedback of the delay information and/or the frequency offset information may lead to invalidation or inaccuracy of the MTRP CSI.

(2) A latest transmission occasion of any reference signal associated with the first CSI report associated with the delay information or the frequency offset information is later than the CSI reference resource associated with the MTRP CSI report and earlier than the feedback slot or the feedback symbol associated with the MTRP CSI report.

For example, when a receiving moment of any one or more reference signals used by the terminal to obtain the first CSI report of the delay information or the frequency offset information is later than the CSI reference resource associated with the MTRP CSI report and earlier than the feedback slot or the feedback symbol associated with the MTRP CSI report, a feedback of the first CSI report of the delay information or the frequency offset information may lead to invalidation or inaccuracy of the MTRP CSI.

(3) A feedback slot or a feedback symbol associated with the first CSI report associated with the delay information or the frequency offset information is later than a CSI reference resource associated with the second CSI report and earlier than a feedback slot or a feedback symbol associated with the second CSI report.

For example, when the feedback slot or the feedback symbol associated with the first CSI report of the delay information or the frequency offset information is later than the CSI reference resource associated with the MTRP CSI report and earlier than the feedback slot or the feedback symbol associated with the MTRP CSI report, the feedback of the first CSI report of the delay information or the frequency offset information may lead to invalidation or inaccuracy of the MTRP CSI.

The latest transmission occasion may be a latest transmission occasion of a reference signal earlier than a CSI reference resource associated with the CSI report of the delay information or the frequency offset information, or a latest transmission occasion of a reference signal earlier than a feedback slot or a feedback symbol associated with the CSI report. The CSI reference resource may be an uplink slot, and may be associated with a downlink slot, a symbol of an uplink slot, or a symbol of a downlink slot. The terminal obtains the CSI based on the CSI reference resource. The feedback slot or the feedback symbol may be a 1^{st} slot or a 1^{st} symbol among all slots or symbols associated with the MTRP CSI report, or may be a slot or a symbol specified in a protocol.

For invalid or inaccurate MTRP CSI or MTRP CSI report, a processing manner of the terminal includes at least one of the following:
(1) the terminal does not feed back the MTRP CSI report;
(2) the terminal feeds back only a part of content of the MTRP CSI report, for example, feeds back only CSI report part1 of the MTRP CSI report, that is, Part1, or feeds back only STRP CSI in the MTRP CSI report, and does not feed back MTRP CSI in the CSI report;
(3) the terminal indicates, in the first CSI report carrying delay information or frequency offset information, whether to feed back the MTRP CSI report. For example, if the terminal finds that the MTRP CSI report is inaccurate or invalid, it may indicate, in the first CSI report carrying delay information or frequency offset information, that the MTRP CSI report is not fed back later. If the terminal finds that the MTRP CSI report is accurate, it may indicate, in the first CSI report carrying delay information or frequency offset information, that the MTRP CSI report is fed back later; or
(4) the terminal indicates, in the first CSI report carrying delay information or frequency offset information, whether to feed back a part of content of the MTRP CSI report. For example, if the terminal finds that the MTRP CSI report is inaccurate or invalid, it may indicate, in the first CSI report carrying delay information or frequency offset information, that the CSI report fed back later includes only CSI report Part1, or that the CSI report does not include MTRP CSI, but includes only STRP CSI.

In the above manner, an invalid or inaccurate MTRP CSI feedback or feedback of an MTRP CSI report may be avoided or reduced, thereby reducing complexity of calculating the MTRP CSI by the terminal and avoiding the problem of transmission performance degradation caused by a feedback of invalid information.

In an optional implementation, the method may further include: determining, by the terminal in a second case, to feed back the second CSI report and perform a second target operation, where the second CSI report includes the MTRP CSI.

The second case may include at least one of the following:
(1) a latest transmission occasion of each reference signal associated with the second CSI report is later than a CSI reference resource associated with the first CSI report and earlier than a feedback slot or a feedback symbol associated with the first CSI report;
(2) a latest transmission occasion of each reference signal associated with the MTRP CSI associated with the second CSI report is later than a CSI reference resource associated with the first CSI report and earlier than a feedback slot or a feedback symbol associated with the first CSI report. That is, a latest transmission occasion of each reference signal associated with MTRP CSI that is associated with the second CSI report is later than the CSI reference resource associated with the first CSI report and earlier than the feedback slot or the feedback symbol associated with the first CSI report;
(3) a latest transmission occasion of any reference signal associated with the second CSI report is later than a CSI reference resource associated with the first CSI report and earlier than a feedback slot or a feedback symbol associated with the first CSI report;
(4) a latest transmission occasion of any reference signal associated with the MTRP CSI associated with the second CSI report is later than a CSI reference resource associated with the first CSI report and earlier than a feedback slot or a feedback symbol associated with the first CSI report. That is, a latest transmission occasion of any reference signal associated with MTRP CSI that is associated with the second CSI report is later than the CSI reference resource associated with the first CSI report and earlier than the feedback slot or the feedback symbol associated with the first CSI report; or
(5) a feedback slot or a feedback symbol associated with the second CSI report is later than a CSI reference resource associated with the first CSI report and earlier than a feedback slot or a feedback symbol associated with the first CSI report.

The second target operation includes at least one of the following:
(a) skipping feeding back the first CSI report;
(b) feeding back a part of content of the first CSI report, for example, feeding back only CSI report part1 of the first CSI report, that is, Part1; or feeding back only frequency offset information in the first CSI report, and skipping feeding back delay information in the CSI report; or feeding back only delay information in the first CSI report, and skipping feeding back frequency offset information in the first CSI report;
(c) indicating, in the second CSI report, whether to feed back the first CSI report; or
(d) indicating, in the second CSI report, whether to feed back a part of content of the first CSI report.

For example, after obtaining a configuration of the reference signal associated with the first CSI report, or after obtaining the reference signal associated with the first CSI report, or after obtaining the target information based on the reference signal associated with the first CSI report, the terminal may determine whether the second case is satisfied. If the second case is satisfied, the terminal determines to feed back the second CSI report, and the terminal does not feed back the first CSI report, or the terminal feeds back only a part of content of the first CSI report, or the terminal indicates, in the second CSI report, whether to feed back the first CSI report or the part of content of the first CSI report.

The latest transmission occasion includes but is not limited to one of the following: a latest transmission occasion of a reference signal earlier than a CSI reference resource associated with the second CSI report, a latest transmission occasion of a reference signal earlier than a feedback slot or a feedback symbol associated with the second CSI report, and a latest transmission occasion of a reference signal earlier than a slot or a symbol specified in a protocol associated with the second CSI report.

In an actual system, there may be MTRP CSI that affects obtaining and feedback of CSI of the delay information or the frequency offset information, so there are some cases in which calculation and feedback of the MTRP CSI make it unnecessary to calculate and feed back the CSI of the delay information or the frequency offset information. For example, in FIG. 4, when the feedback of the MTRP CSI appears between the CSI reference resource associated with the first CSI report carrying the delay information and the frequency offset information and the CSI feedback, because the MTRP CSI carries the delay information, to avoid a redundant feedback of the delay information, the delay information is not fed back in the first CSI report carrying the delay information and the frequency offset information.

For the above case, at least one of the following cases may be included.

A latest transmission occasion of each reference signal associated with the MTRP CSI report is later than a CSI reference resource associated with the first CSI report carrying the delay information or the frequency offset information and earlier than a feedback slot or a feedback symbol associated with the CSI report carrying the delay information and/or the frequency offset information.

A latest transmission occasion of any reference signal associated with the MTRP CSI report is later than a CSI reference resource associated with the first CSI report carrying the delay information or the frequency offset information and earlier than a feedback slot or a feedback symbol associated with the CSI report carrying the delay information and/or the frequency offset information.

A feedback slot or a feedback symbol associated with the MTRP CSI report is later than a CSI reference resource associated with the first CSI report carrying the delay information or the frequency offset information and earlier than a feedback slot or a feedback symbol associated with the CSI report carrying the delay information and/or the frequency offset information.

The latest transmission occasion may be a latest transmission occasion of a reference signal earlier than a CSI reference resource associated with the MTRP CSI report, or a latest transmission occasion of a reference signal earlier than a feedback slot or a feedback symbol associated with the MTRP CSI report.

There is no need to calculate and feed back the CSI of the delay information or the frequency offset information, or only a part of content is fed back, including at least one of the following cases.

The terminal does not feed back the first CSI report carrying delay information or frequency offset information. For example, when the MTRP CSI includes the delay information, and the first CSI report is a CSI report carrying the delay information, if there is an MTRP CSI feedback before a feedback moment of the first CSI report carrying the delay information and after the CSI reference resource associated with the first CSI report carrying the delay information, the CSI report carrying the delay information is not fed back or skips a feedback.

The terminal feeds back only a part of content of the first CSI report carrying delay information or frequency offset information. Optionally, the part of content is a part of content of the delay information, or a part of content of the frequency offset information, or the delay information, or the frequency offset information, or CSI report part1. For example, when the MTRP CSI includes the delay information, and the first CSI report is a CSI report carrying delay information and frequency offset information, if there is an MTRP CSI feedback before a feedback moment of the CSI report carrying delay information and frequency offset information and after the CSI reference resources associated with the CSI report carrying delay information and frequency offset information, only CSI report part1 of the first CSI report of the delay information and the frequency offset information, namely, Part1, is fed back, or only the frequency offset information in the first CSI report of the delay information and the frequency offset information is fed back.

The terminal indicates, in the MTRP CSI report, whether to feed back the first CSI report carrying delay information and/or frequency offset information. For example, if the terminal finds that the MTRP CSI report can accurately carry the delay information or the frequency offset information, it may indicate, in the MTRP CSI report, that there is no first CSI report carrying delay information or frequency offset information later, that is, the first CSI report carrying delay information or frequency offset information skips a feedback.

The terminal indicates, in the MTRP CSI report, whether to feed back a part of content of the first CSI report carrying delay information or frequency offset information. Optionally, the part of content is a part of content of the delay information, or a part of content of the frequency offset information, or the delay information, or the frequency offset information, or CSI report part1. For example, if the terminal finds that the MTRP CSI report can accurately carry the delay information, it may indicate, in the MTRP CSI report, that a later first CSI report carrying delay information and frequency offset information feeds back only the frequency offset information. Alternatively, the terminal may indicate, in the MTRP CSI report, that a later first CSI report carrying delay information and frequency offset information feeds back only CSI report part1.

In the above manner, a repeated feedback of the delay information or the frequency offset information may be avoided or reduced, thereby reducing calculation complexity of the terminal. Further, the network side device may reduce a feedback resource occupied by the CSI report carrying delay information or frequency offset information, and improve a resource utilization rate.

In an optional implementation, the method further includes: obtaining, by the terminal, the second CSI report, where the second CSI report includes the MTRP CSI.

Optionally, a PMI associated with the second CSI report is calculated by referring to a target symbol associated with the CSI reference resource associated with the second CSI report, where the target symbol includes one of the following: a 1^{st} symbol associated with the CSI reference resource, a last symbol associated with the CSI reference resource, and a symbol specified in a protocol among a plurality of symbols associated with the CSI reference resource.

Optionally, in a case that the first CSI report is associated with the second CSI report (for example, having the target association relationship), the PMI associated with the second CSI report is calculated by referring to the target symbol associated with the CSI reference resource associated with the second CSI report. The target symbol may be a 1^{st} symbol or a last symbol among a plurality of symbols associated with the CSI reference resource, or a symbol specified in a protocol. To be specific, the PMI associated with the second CSI report may be calculated based on the CSI reference resource, calculated on the CSI reference resource, compensated to be calculated on the CSI reference resource, or aligned to be calculated on the CSI reference resource, that is, the terminal compensates or adjusts a channel obtained from a measurement occasion of the reference signal associated with the second CSI report, aligns channels of all reference signals to the CSI reference resource, and further obtains the CSI.

Optionally, the terminal may further determine, based on twelfth network signaling, a default rule, or a specification in the protocol, that the PMI associated with the second CSI report is calculated by using a target symbol associated with a CSI reference resource associated with the second CSI report. For example, the terminal determines, by using a network higher layer signaling configuration, whether to calculate the PMI by using the target symbol associated with the CSI reference resource associated with the second CSI report, or when the first CSI report associated with the second CSI report includes frequency offset information, the terminal calculates, by default, the PMI by using the target symbol associated with the CSI reference resource associated with the second CSI report, or when the second CSI report is associated with the first CSI report, the terminal calculates, by default, the PMI by using the target symbol associated with the CSI reference resource associated with the second CSI report.

Optionally, in a case that the CSI reference resource associated with the second CSI report is associated with a slot, the PMI associated with the second CSI report is calculated by referring to the slot associated with the CSI reference resource associated with the second CSI report.

In this embodiment of this application, for obtaining of an MTRP CSI report (the second CSI report), refer to the associated at least one first CSI report including delay information or frequency offset information. A possible reference manner is that the terminal obtains the MTRP CSI report based on a specific time, and the specific time is a time specified by a transceiver. It may be understood that impact of the delay or the frequency offset before the specific time is processed by the terminal, and impact of the delay or the frequency offset after the specific time is processed by the network. In this manner, performance impact caused by repeated processing of the network and the terminal may be effectively avoided, or performance impact caused by a case in which neither the network nor the terminal performs processing may be avoided.

For the specific time, a possible manner is a CSI reference resource, and the CSI reference resource may be a downlink slot or an uplink slot, and may be obtained through network indication, protocol specification, a rule specified in a protocol, or terminal indication. That is, calculation of the PMI associated with the MTRP CSI report needs to refer to the CSI reference resource. For example, the terminal compensates a channel measured at a CSI reference signal (CSI-RS) transmission occasion for the impact of the frequency offset to the CSI reference resource, and then calculates a corresponding MTRP PMI and feeds it back to the network.

For the specific time, another possible manner is a specific symbol of the CSI reference resource, and the specific symbol may be a 1^{st} symbol or a last symbol of the CSI reference resources, a 1^{st} symbol specified in a protocol, a 1^{st} downlink symbol, a 1^{st} uplink symbol, a last downlink symbol, a last uplink symbol, or a 1^{st} non-uplink non-downlink symbol. For example, the terminal compensates a channel measured at a CSI-RS transmission occasion for the impact of the frequency offset to the 1^{st} symbol of the CSI reference resource, and then calculates a corresponding MTRP PMI and feeds it back to the network.

Optionally, for the specific time, the terminal may determine, based on network signaling or a default rule, whether to refer to the 1^{st} symbol or the last symbol of the CSI reference resource, a symbol specified in the protocol, or a slot associated with the CSI reference resource, to calculate the PMI associated with the second CSI report. For example, the network indicates that calculation is performed based on the slot or the 1^{st} symbol. For another example, the protocol specifies a rule that a CSI reference resource including both an uplink symbol and a downlink symbol is calculated based on a 1^{st} downlink symbol, and a CSI reference resource including an uplink symbol and a non-uplink non-downlink symbol is calculated based on a 1^{st} non-uplink non-downlink symbol.

In an optional implementation, before the obtaining, by the terminal, the second CSI report, in a case that the second CSI report is associated with at least one first CSI report, the terminal may determine, based on thirteenth network signaling, one of the following.

(1) The terminal obtains the second CSI report based on a target feedback of the at least one first CSI report associated with the second CSI report, where the target feedback includes one of the following that are not later than the CSI reference resource associated with the second CSI report: a latest feedback, any feedback, and one feedback specified in a protocol. Optionally, the latest feedback is a feedback not later than the CSI reference resource associated with the second CSI report, and any feedback and the feedback specified in the protocol may be a feedback not later than the CSI reference resource associated with the second CSI report.

(2) The terminal does not obtain the second CSI report based on any feedback of the at least one first CSI report associated with the second CSI report. That is, when obtaining the second CSI report, the terminal does not consider feedback content of the at least one first CSI report.

In an optional implementation of this embodiment of this application, for obtaining of an MTRP CSI report (the second CSI report), when the MTRP CSI report is associated with a feedback of the at least one first CSI report including delay information or frequency offset information, if the feedback of the first CSI report including delay information or frequency offset information is a periodic or semi-persistent CSI feedback, the network may indicate, by using signaling, the terminal to obtain the MTRP CSI report based on or referring to (or not referring to) which feedback of the first CSI report, including at least one of the following.

1. The terminal obtains the MTRP CSI report based on a latest feedback of the at least one first CSI report that includes delay information or frequency offset information and that is associated with the MTRP CSI report.

2. The terminal obtains the MTRP CSI report based on a feedback of the at least one first CSI report that includes delay information or frequency offset information and that is associated with the MTRP CSI report.

3. The terminal does not obtain the MTRP CSI report based on any feedback of the at least one first CSI report that includes delay information or frequency offset information and that is associated with the MTRP CSI report. That is, when obtaining the MTRP CSI report, the terminal does not consider feedback content of the at least one first CSI report.

Optionally, the latest feedback is a feedback not later than the CSI reference resource associated with the second CSI report; and the feedback may be any feedback or a feedback specified in the protocol.

In this manner, the network side device may control whether the terminal obtains the MTRP CSI report based on a latest feedback of the first CSI report of the delay information or the frequency offset information, thereby improving an accuracy of the MTRP CSI report. Alternatively, when the network side device does not receive the latest feedback of the first CSI report of the delay information or the frequency offset information, the terminal is indicated to obtain the MTRP CSI report based on a previous feedback, or obtain the MTRP CSI report without referring to the feedback of the first CSI report of the delay information or the frequency offset information. Thereby avoiding impact caused by the inaccurate MTRP CSI report and improving configuration flexibility of the network side device.

In an optional implementation, in a case that the second CSI report is associated with the at least one first CSI report, the terminal may obtain the second CSI report based on at least one of the following:

(1) obtaining, by the terminal, a target value based on a default rule or fourteenth network signaling sent by the network side device, and obtaining the second CSI report based on the target value, where the target value includes one of the following: a frequency offset value, a delay value, an offset value of a frequency offset, and an offset of a delay; or

(2) determining, by the terminal based on fifteenth network signaling sent by the network side device, to obtain the second CSI report by referring to all or a part of the target information of the at least one first CSI report.

In an optional implementation of this embodiment of this application, for obtaining of an MTRP CSI report (the second CSI report), when the MTRP CSI report is associated with a feedback of the at least one first CSI report including delay information or frequency offset information, and the at least one first CSI report including delay information or frequency offset information is associated with a plurality of pieces of delay information or frequency offset information, the network side device may select at least a part of delay information and/or frequency offset information from the plurality of pieces of delay information or frequency offset information by using the signaling or the transceiver through the default rule, to obtain the MTRP CSI report. In this manner, implementation complexity of the network side device may be simplified, and some delay information or frequency offset information is processed by the terminal.

That the network side device may select at least a part of delay information or frequency offset information from the plurality of pieces of delay information or frequency offset information by using the signaling or the transceiver through the default rule, to obtain the MTRP CSI report includes at least one of the following implementations.

Implementation 1: The terminal obtains a first value based on network signaling indicated by the network side device, and the terminal obtains the MTRP CSI report based on the first value, where the first value may be a frequency offset value, a delay value, an offset value of a frequency offset, or a value of a delay offset. When obtaining the MTRP CSI report, the terminal needs to consider at least a part of delay information or frequency offset information greater than or equal to the first value among the plurality of pieces of delay information or frequency offset information. In other words, when obtaining the MTRP CSI report, the terminal does not refer to at least a part of delay information or frequency offset information smaller than or equal to the first value among the plurality of pieces of delay information or frequency offset information.

Implementation 2: The terminal determines a second value based on the default rule, and the terminal obtains the MTRP CSI report based on the second value, where the second value is a frequency offset value, a delay value, an offset value of a frequency offset, or a value of a delay offset. The default rule may be that the terminal determines the second value by using a bandwidth or a carrier interval associated with the MTRP CSI report. Alternatively, the default rule may be that the terminal obtains the second value based on a measurement configuration or a report configuration associated with the MTRP CSI report. When obtaining the MTRP CSI report, the terminal needs to consider at least a part of delay information or frequency offset information greater than or equal to the second value among the plurality of pieces of delay information or frequency offset information. In other words, when obtaining the MTRP CSI report, the terminal does not refer to at least a part of delay information or frequency offset information smaller than or equal to the second value among the plurality of pieces of delay information or frequency offset information.

Further, when the terminal obtains the second CSI report, the network side device may indicate, by using higher layer signaling, whether to refer to all delay information or frequency offset information of the at least one CSI report, or refer to a part of delay information or frequency offset information of the at least one CSI report. Alternatively, when the higher layer signaling is not configured, the terminal refers to all the delay information or the frequency offset information.

Through the technical solutions provided in this embodiment of this application, the terminal may receive the network signaling sent by the network side device or an activated CSI report configuration, to obtain one or more types of information of the delay information and the frequency offset information, and feed back the information to the network by using the CSI report, which facilitates synchronization of the network and the terminal, to realize better MTRP transmission subsequently.

In addition, priorities of the MTRP CSI report and the CSI report carrying delay information or frequency offset information are defined, to avoid inconsistent understanding between the terminal and the network in the priority of the CSI report, which leads to an error in parsing the CSI report by the network. In addition, by defining some terminal processing manners in a special timing relationship, an invalid or inaccurate MTRP CSI feedback or feedback of an MTRP CSI report may be avoided or reduced, thereby reducing complexity of calculating the MTRP CSI by the terminal. Alternatively, a repeated feedback of the delay information or the frequency offset information may be avoided or reduced, thereby reducing calculation complexity of the terminal. Further, the network side device may reduce a feedback resource occupied by the CSI report carrying delay information or frequency offset information, and improve a resource utilization rate.

Optionally, the association described in the embodiments of this application is not limited to the following explanations:
that A is associated with B indicates that A is B;
that A is associated with B indicates that B can be obtained by using A; and
that A is associated with B indicates that B can be determined by using A.

Based on the same technical concept, an embodiment of this application further provides a method for configuring a channel state information report.

FIG. 5 is a schematic flowchart of a method for configuring a channel state information report according to an embodiment of this application. The method 500 may be performed by a network side device. In other words, the method may be performed by software or hardware installed in the network side device. It should be noted that the following embodiment describes only an operation of the network side device, and for other matters not covered, refer to the related description about method 200.

As shown in FIG. 5, the method may include the following steps.

S510: A network side device sends first network signaling to a terminal, where the first network signaling is used to configure a first CSI report fed back by the terminal to include target information, and the target information includes at least one of the following: delay information or frequency offset information.

In this embodiment of this application, the network side device may configure, by using network signaling, the first CSI report fed back by the terminal to include delay information, frequency offset information, or delay information and frequency offset information, or may indicate, by using the DCI, to the terminal that the first CSI report fed back by the terminal includes delay information, frequency offset information, or delay information and frequency offset information. In this way, the network side device may flexibly adjust content in the CSI report based on known information or channel reciprocity, to avoid feedback of some useless information.

In an optional implementation, the method may further include at least one of the following.

(1) The network side device sends second network signaling to the terminal, where the second network signaling indicates at least one first reference signal or at least one first reference signal set associated with the delay information, and the first reference signal set includes at least one first reference signal.

(2) The network side device sends third network signaling to the terminal, where the third network signaling indicates at least one second reference signal or at least one second reference signal set associated with the frequency offset information, and the second reference signal set includes at least one second reference signal.

In the optional implementation, the network side device may control content and a size of the CSI report by indicating a reference signal or a reference signal set to the terminal, thereby avoiding feedback of some useless information and reducing network signaling overheads.

(3) The network side device sends fourth network signaling to the terminal, where the fourth network signaling indicates an accuracy of the delay information.

(4) The network side device sends fifth network signaling to the terminal, where the fifth network signaling indicates an accuracy of the frequency offset information.

In the optional implementation, the network side device may further indicate a granularity of the delay information or the frequency offset information to the terminal by using network signaling, that is, the network side device may control an accuracy or a unit of the delay information and/or the frequency offset information fed back by the terminal, to avoid feeding back a large delay or frequency offset with a high accuracy, and feeding back a small delay or frequency offset with a low accuracy, thereby effectively utilizing feedback resources and improving effectiveness of feedback information.

(5) The network side device sends sixth network signaling to the terminal, where the sixth network signaling indicates a quantity of pieces of delay information included in the first CSI report.

In the optional implementation, the network side device may further indicate, to the terminal by using network signaling, the quantity of pieces of delay information included in the CSI report, and the terminal may select, based on the determined quantity of pieces of delay information, a proper reference signal or reference signal set to feed back delay information associated with the terminal. In this case, a part of delay information fed back by the terminal may be invalid or specific, indicating that the delay information associated with a corresponding reference signal or reference signal set exceeds an available range.

(6) The network side device sends seventh network signaling to the terminal, where the seventh network signaling indicates a maximum quantity of pieces of delay information included in the first CSI report.

In the optional implementation, the network side device may further indicate, to the terminal by using network signaling, a maximum quantity of pieces of delay information included in the CSI report, and the terminal selects a proper reference signal or reference signal set to feed back delay information associated with the terminal. In these manners, quality of the delay information or the frequency offset information in the CSI report may be effectively improved, and feedback of too many values exceeding a processing range may be avoided.

(7) The network side device sends eighth network signaling to the terminal, where the eighth network signaling indicates a quantity of pieces of frequency offset information included in the first CSI report.

(8) The network side device sends ninth network signaling to the terminal, where the ninth network signaling indicates a maximum quantity of pieces of frequency offset information included in the first CSI report.

In the optional implementation, the quantity or the maximum quantity of pieces of frequency offset information included in the first CSI report may be indicated to the terminal by the network side device by using the network signaling.

Optionally, a quantity or a maximum quantity of frequency offset information-delay information pairs included in the first CSI report may also be indicated to the terminal by using the network signaling. In these manners, quality of the delay information or the frequency offset information in the CSI report may be effectively improved, and feedback of too many values exceeding a processing range may be avoided.

In an optional implementation, in a case that the first CSI report includes the frequency offset information, the frequency offset information included in the first CSI report includes one of the following:
a frequency offset associated with each second reference signal;
a frequency offset associated with each second reference signal set;
an offset value of a frequency offset of each second reference signal relative to a frequency offset associated with a benchmark reference signal; and
an offset value of a frequency offset of each second reference signal set relative to a frequency offset associated with a benchmark reference signal set.

In an optional implementation, in a case that the first CSI report includes the frequency offset information, and the frequency offset information includes the frequency offset associated with each second reference signal or the frequency offset associated with each second reference signal set, a quantity of the frequency offsets included in the first CSI report is one of the following:
a total quantity of second reference signals associated with the first CSI report;
a total quantity of second reference signal sets associated with the first CSI report;
a total quantity of second reference signals indicated by the network side device;
a total quantity of second reference signal sets indicated by the network side device;
a total quantity of second reference signals selected by the terminal; and
a total quantity of second reference signal sets selected by the terminal.

In an optional implementation, in a case that the frequency offset information includes the frequency offset, after the terminal feeds back the first CSI report, the method further includes: determining, by the network side device, that a reference signal associated with the first CSI report or a physical downlink channel associated with the first CSI report has no frequency offset, or determining, by the network side device, that a reference signal associated with the first CSI report or a physical downlink channel associated with the first CSI report has no offset value of the frequency offset.

In an optional implementation, the first CSI report includes the frequency offset information, and the frequency offset information includes the offset value of a frequency offset of each second reference signal relative to a frequency offset associated with a benchmark reference signal or the offset value of a frequency offset of each second reference signal set relative to a frequency offset associated with a benchmark reference signal set. A quantity of offset values of the frequency offset included in the first CSI report is one of the following:
a total quantity of second reference signals associated with the first CSI report is reduced by 1;
a total quantity of second reference signal sets associated with the first CSI report is reduced by 1;
a total quantity of second reference signals indicated by the network side device is reduced by 1;
a total quantity of second reference signal sets indicated by the network side device is reduced by 1;
a total quantity of second reference signals selected by the terminal is reduced by 1;and
a total quantity of second reference signal sets selected by the terminal is reduced by 1.

In an optional implementation, the first CSI report includes the frequency offset information, and the frequency offset information includes the offset value of a frequency offset of each second reference signal relative to a frequency offset associated with a benchmark reference signal or the offset value of a frequency offset of each second reference signal set relative to a frequency offset associated with a benchmark reference signal set. A quantity of offset values of the frequency offset included in the first CSI report is one of the following:
a total quantity of second reference signals associated with the first CSI report is reduced by N;
a total quantity of second reference signal sets associated with the first CSI report is reduced by N;
a total quantity of second reference signals indicated by the network side device is reduced by N;
a total quantity of second reference signal sets indicated by the network side device is reduced by N;
a total quantity of second reference signals selected by the terminal is reduced by N; and
a total quantity of second reference signal sets selected by the terminal is reduced by N.

N is an integer greater than 1. For example, the benchmark reference signal or the benchmark reference signal set may be N of the plurality of second reference signals or second reference signal sets associated with the first CSI report, for example, first N or last N, or N of the plurality of second reference signals or second reference signal sets indicated by the network side device, or N of the plurality of second reference signals or second reference signal sets selected or indicated by the terminal.

In an optional implementation, the method further includes:
sending, by the network side device, tenth network signaling to the terminal, where the tenth network signaling indicates that the frequency offset information includes the frequency offset or the offset value of the frequency offset.

In an optional implementation, the method further includes:
receiving, by the network side device, the first CSI report fed back by the terminal.

In an optional implementation, the method further includes:
determining, by the network side device in a first case, that the terminal is to feed back the first CSI report and perform a first target operation.

The first case includes at least one of the following:
a latest transmission occasion of each reference signal associated with the first CSI report is later than a CSI reference resource associated with the second CSI report and earlier than a feedback slot or a feedback symbol associated with the second CSI report, and the second CSI report includes MTRP CSI;
a latest transmission occasion of any reference signal associated with the first CSI report is later than a CSI reference resource associated with the second CSI report and earlier than a feedback slot or a feedback symbol associated with the second CSI report; or
a feedback slot or a feedback symbol associated with the first CSI report is later than a CSI reference resource associated with the second CSI report and earlier than a feedback slot or a feedback symbol associated with the second CSI report.

The first target operation includes at least one of the following:
skipping feeding back the second CSI report;
feeding back a part of content of the second CSI report;
indicating, in the first CSI report, whether to feed back the second CSI report; or
indicating, in the first CSI report, whether to feed back a part of content of the second CSI report.

Because the CSI of the delay information or the frequency offset information may affect calculation of the MTRP CSI, there are some cases in which a CSI feedback of the delay information or the frequency offset information may lead to invalidation or inaccuracy of the MTRP CSI, resulting in performance loss. Therefore, in the optional implementation, when the network side device determines that the first case is satisfied, in an implementation, it is determined that the terminal feeds back the first CSI report, and does not feed back the second CSI report. In another implementation, it is determined that the terminal feeds back only a part of content of the second CSI report. In still another implementation, it is determined that the terminal indicates, in the first CSI report, that the terminal feeds back the second CSI report or a part of content of the second CSI report. Further, it is determined, based on the indication in the first CSI report, that the terminal feeds back the second CSI report or a part of content of the second CSI report. Therefore, an invalid or inaccurate MTRP CSI feedback or feedback of an MTRP CSI report may be avoided or reduced, thereby reducing complexity of calculating the MTRP CSI by the terminal and avoiding the problem of transmission performance degradation caused by a feedback of invalid information.

In an optional implementation, the method further includes: determining, by the network side device in a second case, that the terminal feeds back the second CSI report and performs a second target operation, where the second CSI report includes MTRP CSI.

The second case includes at least one of the following:
a latest transmission occasion of each reference signal associated with the second CSI report is later than a CSI reference resource associated with the first CSI report and earlier than a feedback slot or a feedback symbol associated with the first CSI report;
a latest transmission occasion of each reference signal associated with the MTRP CSI associated with the second CSI report is later than a CSI reference resource associated with the first CSI report and earlier than a feedback slot or a feedback symbol associated with the first CSI report;
a latest transmission occasion of any reference signal associated with the second CSI report is later than a CSI reference resource associated with the first CSI report and earlier than a feedback slot or a feedback symbol associated with the first CSI report;
a latest transmission occasion of any reference signal associated with the MTRP CSI associated with the second CSI report is later than a CSI reference resource associated with the first CSI report and earlier than a feedback slot or a feedback symbol associated with the first CSI report; or
a feedback slot or a feedback symbol associated with the second CSI report is later than a CSI reference resource associated with the first CSI report and earlier than a feedback slot or a feedback symbol associated with the first CSI report.

The second target operation includes at least one of the following:
skipping feeding back the first CSI report;
feeding back a part of content of the first CSI report;
indicating, in the second CSI report, whether to feed back the first CSI report; or
indicating, in the second CSI report, whether to feed back a part of content of the first CSI report.

In the optional implementation, when the network side device determines that the second case is satisfied, in an implementation, it is determined that the terminal feeds back the second CSI report, and does not feed back the first CSI report. In another implementation, it is determined that the terminal feeds back only a part of content of the first CSI report. In still another implementation, it is determined that the terminal indicates, in the second CSI report, that the terminal feeds back the first CSI report or a part of content of the first CSI report. Further, it is determined, based on the indication in the second CSI report, that the terminal feeds back the first CSI report or a part of content of the first CSI report. Therefore, a repeated feedback of the delay information or the frequency offset information may be avoided or reduced, thereby reducing calculation complexity of the terminal. Further, the network side device may reduce a feedback resource occupied by the CSI report carrying delay information or frequency offset information, and improve a resource utilization rate.

In an optional implementation, the method may further include: sending, by the network side device, twelfth network signaling to the terminal, where the twelfth network signaling indicates that PMI associated with the second CSI report is calculated by using a target symbol associated with a CSI reference resource associated with the second CSI report, where the second CSI report includes multi-transmission and reception point (MTRP) CSI.

In an optional implementation, the method may further include: sending, by the network side device, thirteenth network signaling to the terminal, where the thirteenth network signaling indicates one of the following:
obtaining, by the terminal, the second CSI report based on a target feedback of the at least one first CSI report associated with the second CSI report, where the target feedback includes one of the following that are not later than the CSI reference resource associated with the second CSI report: a latest feedback, any feedback, and one feedback specified in a protocol; and
skipping obtaining, by the terminal, the second CSI report based on any feedback of the at least one first CSI report associated with the second CSI report.

In an optional implementation, the method may further include at least one of the following:
sending, by the network side device, fourteenth network signaling to the terminal, where the fourteenth network signaling indicates the terminal to obtain the second CSI report based on a target value, and the target value includes one of the following: a frequency offset value, a delay value, an offset value of a frequency offset, and a delay offset; and
sending, by the network side device, fifteenth network signaling to the terminal, where the fifteenth network signaling indicates to obtain the second CSI report by referring to all or a part of the target information of the at least one first CSI report.

Through the method provided in this embodiment of this application, the network side device may obtain one or more types of information of the delay information and the frequency offset information by sending a network signaling configuration. By defining some terminal processing manners in a special timing relationship, an invalid or inaccurate MTRP CSI feedback or feedback of an MTRP CSI report may be avoided or reduced, thereby reducing complexity of calculating the MTRP CSI by the terminal. Alternatively, a repeated feedback of the delay information or the frequency offset information may be avoided or reduced, thereby reducing calculation complexity of the terminal. Further, the network side device may reduce a feedback resource occupied by the CSI report carrying delay information or frequency offset information, and improve a resource utilization rate.

The method for obtaining a channel state information report provided in this embodiment of this application may be executed by an apparatus for obtaining a channel state information report. In the embodiments of this application, that the apparatus for obtaining a channel state information report performs the method for obtaining a channel state information report is used as an example to describe the apparatus for obtaining a channel state information report provided in the embodiments of this application.

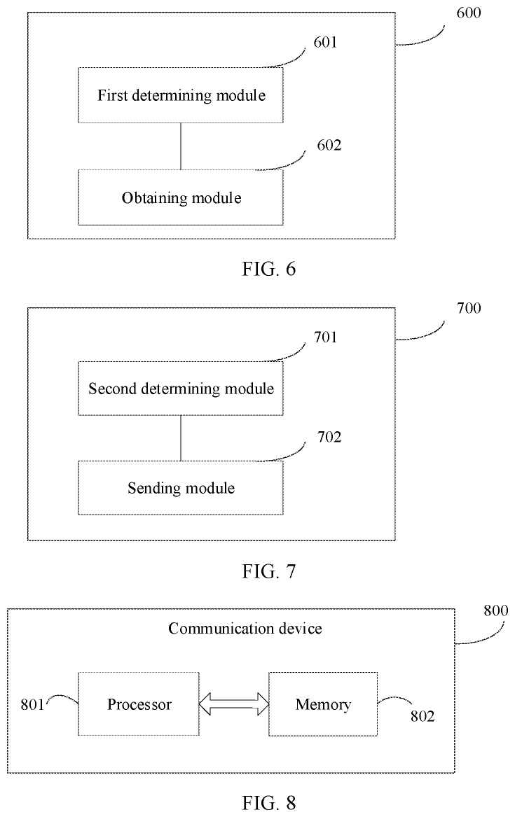

FIG. 6 is a schematic diagram of a structure of an apparatus for obtaining a channel state information report according to an embodiment of this application. As shown in FIG. 6, the apparatus mainly includes a first determining module 601 and an obtaining module 602.

In this embodiment of this application, the first determining module 601 is configured to determine that a first CSI report to be fed back currently includes target information, where the target information includes at least one of the following: delay information or frequency offset information; and the obtaining module 602 is configured to obtain the target information based on a reference signal associated with the first CSI report.

In an optional implementation, the determining that a first channel state information (CSI) report to be fed back currently includes target information includes:
determining, based on first network signaling sent by a network side device, that the first CSI report includes the target information.

In an optional implementation, the first determining module 601 is further configured to perform at least one of the following:
determining, based on second network signaling sent by a network side device, at least one first reference signal or at least one first reference signal set associated with the delay information, where the first reference signal set includes at least one first reference signal;
determining, based on third network signaling sent by a network side device, at least one second reference signal or at least one second reference signal set associated with the frequency offset information, where the second reference signal set includes at least one second reference signal;
determining, based on fourth network signaling sent by a network side device, an accuracy of the delay information;
determining, based on fifth network signaling sent by a network side device, an accuracy of the frequency offset information;
determining, based on sixth network signaling sent by a network side device, a quantity of pieces of delay information included in the first CSI report;
determining, based on seventh network signaling sent by a network side device, a maximum quantity of pieces of delay information included in the first CSI report;
determining, based on eighth network signaling sent by a network side device, a quantity of pieces of frequency offset information included in the first CSI report; or
determining, based on ninth network signaling sent by a network side device, a maximum quantity of pieces of frequency offset information included in the first CSI report.

In an optional implementation, in a case that the first CSI report includes the frequency offset information, the frequency offset information included in the first CSI report includes one of the following:
a frequency offset associated with each second reference signal;
a frequency offset associated with each second reference signal set;
an offset value of a frequency offset of each second reference signal relative to a frequency offset associated with a benchmark reference signal; and
an offset value of a frequency offset of each second reference signal set relative to a frequency offset associated with a benchmark reference signal set.

In an optional implementation, in a case that the first CSI report includes the frequency offset (that is, the frequency offset includes a frequency offset of each second reference signal or a frequency offset of each second reference signal set), a quantity of the frequency offsets included in the first CSI report is one of the following:
a total quantity of second reference signals associated with the first CSI report;
a total quantity of second reference signal sets associated with the first CSI report;
a total quantity of second reference signals indicated by the network side device;
a total quantity of second reference signal sets indicated by the network side device;
a total quantity of second reference signals selected by the terminal; and
a total quantity of second reference signal sets selected by the terminal.

In an optional implementation, the first determining module 601 is further configured to: in a case that the frequency offset information includes the frequency offset, after feeding back the first CSI report, determine that a reference signal associated with the first CSI report or a physical downlink channel associated with the first CSI report has no frequency offset, or determine that a reference signal associated with the first CSI report or a physical downlink channel associated with the first CSI report has no offset value of the frequency offset.

In an optional implementation, in a case that the first CSI report includes the offset value of the frequency offset (that is, the frequency offset includes an offset value of a frequency offset of each second reference signal relative to a frequency offset associated with a benchmark reference signal or an offset value of a frequency offset of each second reference signal set relative to a frequency offset associated with a benchmark reference signal set), a quantity of offset values of the frequency offset included in the first CSI report is one of the following:
a total quantity of second reference signals associated with the first CSI report is reduced by 1;
a total quantity of second reference signal sets associated with the first CSI report is reduced by 1;
a total quantity of second reference signals indicated by the network side device is reduced by 1;
a total quantity of second reference signal sets indicated by the network side device is reduced by 1;
a total quantity of second reference signals selected by the terminal is reduced by 1;and
a total quantity of second reference signal sets selected by the terminal is reduced by 1.

In an optional implementation, in a case that the first CSI report includes the offset value of the frequency offset (that is, the frequency offset includes an offset value of a frequency offset of each second reference signal relative to a frequency offset associated with a benchmark reference signal or an offset value of a frequency offset of each second reference signal set relative to a frequency offset associated with a benchmark reference signal set), a quantity of offset values of the frequency offset included in the first CSI report is one of the following:
a total quantity of second reference signals associated with the first CSI report is reduced by N;
a total quantity of second reference signal sets associated with the first CSI report is reduced by N;
a total quantity of second reference signals indicated by the network side device is reduced by N;
a total quantity of second reference signal sets indicated by the network side device is reduced by N;
a total quantity of second reference signals selected by the terminal is reduced by N; and
a total quantity of second reference signal sets selected by the terminal is reduced by N.

N is an integer greater than 1. For example, the benchmark reference signal or the benchmark reference signal set may be N of the plurality of second reference signals or second reference signal sets associated with the first CSI report, for example, first N or last N, or N of the plurality of second reference signals or second reference signal sets indicated by the network side device, or N of the plurality of second reference signals or second reference signal sets selected or indicated by the terminal.

In an optional implementation, the first determining module 601 is further configured to determine, based on tenth network signaling sent by the network side device, that the frequency offset information includes the frequency offset or the offset value of the frequency offset.

In an optional implementation, the apparatus further includes a feedback module, configured to feed back the first CSI report, where a feedback priority of the first CSI report is higher than that of a second CSI report, and the second CSI report includes multi-transmission and reception point (MTRP) CSI.

In an optional implementation, the first CSI report and the second CSI report satisfy at least one of the following:
the first CSI report and the second CSI report are associated with a same CSI report type, where the CSI report type includes one of the following: a periodic CSI report, a semi-persistent CSI report, and an aperiodic CSI report;
the first CSI report and the second CSI report are associated with a same channel type, where the channel type includes one of the following: a physical uplink shared channel (PUSCH) and a physical uplink control channel (PUCCH);
the first CSI report and the second CSI report are associated with a same serving cell; or
the first CSI report and the second CSI report have a target association relationship, where the target association relationship includes at least one of the following:
a quasi-co-location reference signal of a reference signal existing in reference signals associated with the second CSI report is the reference signal associated with the first CSI report;
an association relationship that is between the second CSI report and the first CSI report and that is indicated by eleventh network signaling associated with the second CSI report, where the eleventh network signaling includes one of the following: CSI report configuration signaling and serving cell configuration signaling;
an association relationship that is between the second CSI report and the first CSI report and that is established by using a physical cell identifier; or
an association relationship that is between the second CSI report and the first CSI report and that is established by using a measurement bandwidth part.

In an optional implementation, the first determining module is further configured to determine, in a first case, to feed back the first CSI report and perform a first target operation.

The first case includes at least one of the following:
a latest transmission occasion of each reference signal associated with the first CSI report is later than a CSI reference resource associated with the second CSI report and earlier than a feedback slot or a feedback symbol associated with the second CSI report, and the second CSI report includes MTRP CSI;
a latest transmission occasion of any reference signal associated with the first CSI report is later than a CSI reference resource associated with the second CSI report and earlier than a feedback slot or a feedback symbol associated with the second CSI report; or
a feedback slot or a feedback symbol associated with the first CSI report is later than a CSI reference resource associated with the second CSI report and earlier than a feedback slot or a feedback symbol associated with the second CSI report.

The first target operation includes at least one of the following:
skipping feeding back the second CSI report;
feeding back a part of content of the second CSI report;
indicating, in the first CSI report, whether to feed back the second CSI report; or
indicating, in the first CSI report, whether to feed back a part of content of the second CSI report.

In an optional implementation, the first determining module 601 is further configured to determine to feed back the second CSI report and perform a second target operation, where the second CSI report includes the MTRP CSI.

The second case includes at least one of the following:
a latest transmission occasion of each reference signal associated with the second CSI report is later than a CSI reference resource associated with the first CSI report and earlier than a feedback slot or a feedback symbol associated with the first CSI report;
a latest transmission occasion of each reference signal associated with the MTRP CSI associated with the second CSI report is later than a CSI reference resource associated with the first CSI report and earlier than a feedback slot or a feedback symbol associated with the first CSI report;
a latest transmission occasion of any reference signal associated with the second CSI report is later than a CSI reference resource associated with the first CSI report and earlier than a feedback slot or a feedback symbol associated with the first CSI report;
a latest transmission occasion of any reference signal associated with the MTRP CSI associated with the second CSI report is later than a CSI reference resource associated with the first CSI report and earlier than a feedback slot or a feedback symbol associated with the first CSI report; or
a feedback slot or a feedback symbol associated with the second CSI report is later than a CSI reference resource associated with the first CSI report and earlier than a feedback slot or a feedback symbol associated with the first CSI report.

The second target operation includes at least one of the following:
skipping feeding back the first CSI report;
feeding back a part of content of the first CSI report;
indicating, in the second CSI report, whether to feed back the first CSI report; or
indicating, in the second CSI report, whether to feed back a part of content of the first CSI report.

In an optional implementation, the obtaining module 602 is further configured to obtain the second CSI report, where the second CSI report includes multi-transmission and reception point (MTRP) CSI.

In an optional implementation, a PMI associated with the second CSI report is calculated by referring to a target symbol associated with the CSI reference resource associated with the second CSI report, where the target symbol includes one of the following: a 1^{st} symbol associated with the CSI reference resource, a last symbol associated with the CSI reference resource, and a symbol specified in a protocol among a plurality of symbols associated with the CSI reference resource.

In an optional implementation, in a case that the first CSI report is associated with the second CSI report, the PMI associated with the second CSI report is calculated by referring to the target symbol associated with the CSI reference resource associated with the second CSI report.

In an optional implementation, the first determining module 601 is further configured to determine, based on twelfth network signaling, a default rule, or a specification in the protocol, that the PMI associated with the second CSI report is calculated by using a target symbol associated with a CSI reference resource associated with the second CSI report.

In an optional implementation, in a case that the CSI reference resource associated with the second CSI report is associated with a slot, the PMI associated with the second CSI report is calculated by referring to the slot associated with the CSI reference resource associated with the second CSI report.

In an optional implementation, the first determining module 601 is further configured to: in a case that the second CSI report is associated with at least one first CSI report, determine, based on thirteenth network signaling, one of the following:
obtaining the second CSI report based on a target feedback of at least one first CSI report associated with the second CSI report, where the target feedback includes one of the following that are not later than the CSI reference resource associated with the second CSI report: a latest feedback, any feedback, and one feedback specified in a protocol; and
skipping obtaining the second CSI report based on any feedback of the at least one first CSI report associated with the second CSI report.

In an optional implementation, the obtaining the second CSI report includes:
in a case that the second CSI report is associated with at least one first CSI report, obtaining the second CSI report based on at least one of the following:
obtaining a target value based on a default rule or fourteenth network signaling sent by the network side device, and obtaining the second CSI report based on the target value, where the target value includes one of the following: a frequency offset value, a delay value, an offset value of a frequency offset, and a delay offset; or
determining, based on fifteenth network signaling sent by the network side device, to obtain the second CSI report by referring to all or a part of the target information of the at least one first CSI report.

In an optional implementation, a quantity of CSI processing units (CPU) associated with the first CSI report is related to at least one of the following:
a quantity of reference signal sets associated with the first CSI report; or
the target information included in the first CSI report.

In an optional implementation, the obtaining module 602 is further configured to: in a case that the target information included in the first CSI report is a delay offset or an offset value of a frequency offset, carrying target indication information in the first CSI report, where the target indication information indicates a reference signal or a reference signal set referenced by the target information.

The apparatus for obtaining a channel state information report in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The apparatus for obtaining a channel state information report provided in this embodiment of this application can implement the processes implemented in the method embodiment in FIG. 2, and achieve a same technical effect. To avoid repetition, details are not described herein again.

FIG. 7 is a schematic diagram of a structure of an apparatus for configuring a channel state information report according to an embodiment of this application. As shown in FIG. 7, the apparatus mainly includes a second determining module 701 and a sending module 702.

In this embodiment of this application, the second determining module 701 is configured to determine that a first CSI report fed back by a terminal includes target information, where the target information includes at least one of the following: delay information or frequency offset information; and the sending module 702 is configured to send first network signaling to a terminal, where the first network signaling is used to configure a first CSI report fed back by the terminal to include the target information.

In an optional implementation, the sending module 702 is further configured to perform at least one of the following:
sending second network signaling to the terminal, where the second network signaling indicates at least one first reference signal or at least one first reference signal set associated with the delay information, and the first reference signal set includes at least one first reference signal;
sending third network signaling to the terminal, where the third network signaling indicates at least one second reference signal or at least one second reference signal set associated with the frequency offset information, and the second reference signal set includes at least one second reference signal;
sending fourth network signaling to the terminal, where the fourth network signaling indicates an accuracy of the delay information;
sending fifth network signaling to the terminal, where the fifth network signaling indicates an accuracy of the frequency offset information;
sending sixth network signaling to the terminal, where the sixth network signaling indicates a quantity of pieces of delay information included in the first CSI report;
sending seventh network signaling to the terminal, where the seventh network signaling indicates a maximum quantity of pieces of delay information included in the first CSI report;
sending eighth network signaling to the terminal, where the eighth network signaling indicates a quantity of pieces of frequency offset information included in the first CSI report; or
sending ninth network signaling to the terminal, where the ninth network signaling indicates a maximum quantity of pieces of frequency offset information included in the first CSI report.

In an optional implementation, in a case that the first CSI report includes the frequency offset information, the frequency offset information included in the first CSI report includes one of the following:
a frequency offset associated with each second reference signal;
a frequency offset associated with each second reference signal set;
an offset value of a frequency offset of each second reference signal relative to a frequency offset associated with a benchmark reference signal; and
an offset value of a frequency offset of each second reference signal set relative to a frequency offset associated with a benchmark reference signal set.

In an optional implementation, a quantity of the frequency offsets included in the first CSI report is one of the following:
a total quantity of second reference signals associated with the first CSI report;
a total quantity of second reference signal sets associated with the first CSI report;
a total quantity of second reference signals indicated by the network side device;
a total quantity of second reference signal sets indicated by the network side device;
a total quantity of second reference signals selected by the terminal; and
a total quantity of second reference signal sets selected by the terminal.

In an optional implementation, the second determining module 701 is further configured to determine that a reference signal associated with the first CSI report or a physical downlink channel associated with the first CSI report has no frequency offset, or determine that a reference signal associated with the first CSI report or a physical downlink channel associated with the first CSI report has no offset value of the frequency offset.

In an optional implementation, a quantity of offset values of the frequency offset included in the first CSI report is one of the following:
a total quantity of second reference signals associated with the first CSI report is reduced by 1;
a total quantity of second reference signal sets associated with the first CSI report is reduced by 1;
a total quantity of second reference signals indicated by the network side device is reduced by 1;
a total quantity of second reference signal sets indicated by the network side device is reduced by 1;
a total quantity of second reference signals selected by the terminal is reduced by 1; and
a total quantity of second reference signal sets selected by the terminal is reduced by 1.

In an optional implementation, the sending module 702 is further configured to send tenth network signaling to the terminal, where the tenth network signaling indicates that the frequency offset information includes the frequency offset or the offset value of the frequency offset.

In an optional implementation, the apparatus further includes: a receiving module, configured to receive the first CSI report fed back by the terminal.

In an optional implementation, the second determining module 701 is further configured to determine, in a first case, that the terminal is to feed back the first CSI report and perform a first target operation.

The first case includes at least one of the following:
a latest transmission occasion of each reference signal associated with the first CSI report is later than a CSI reference resource associated with the second CSI report and earlier than a feedback slot or a feedback symbol associated with the second CSI report, and the second CSI report includes MTRP CSI;
a latest transmission occasion of any reference signal associated with the first CSI report is later than a CSI reference resource associated with the second CSI report and earlier than a feedback slot or a feedback symbol associated with the second CSI report; or
a feedback slot or a feedback symbol associated with the first CSI report is later than a CSI reference resource associated with the second CSI report and earlier than a feedback slot or a feedback symbol associated with the second CSI report.

The first target operation includes at least one of the following:
skipping feeding back the second CSI report;
feeding back a part of content of the second CSI report;
indicating, in the first CSI report, whether to feed back the second CSI report; or
indicating, in the first CSI report, whether to feed back a part of content of the second CSI report.

In an optional implementation, the second determining module 701 is further configured to determine, in a second case, that the terminal feeds back the second CSI report and performs a second target operation, where the second CSI report includes MTRP CSI.

The second case includes at least one of the following:
a latest transmission occasion of each reference signal associated with the second CSI report is later than a CSI reference resource associated with the first CSI report and earlier than a feedback slot or a feedback symbol associated with the first CSI report;
a latest transmission occasion of each reference signal associated with the MTRP CSI associated with the second CSI report is later than a CSI reference resource associated with the first CSI report and earlier than a feedback slot or a feedback symbol associated with the first CSI report;
a latest transmission occasion of any reference signal associated with the second CSI report is later than a CSI reference resource associated with the first CSI report and earlier than a feedback slot or a feedback symbol associated with the first CSI report;
a latest transmission occasion of any reference signal associated with the MTRP CSI associated with the second CSI report is later than a CSI reference resource associated with the first CSI report and earlier than a feedback slot or a feedback symbol associated with the first CSI report; or
a feedback slot or a feedback symbol associated with the second CSI report is later than a CSI reference resource associated with the first CSI report and earlier than a feedback slot or a feedback symbol associated with the first CSI report.

The second target operation includes at least one of the following:
skipping feeding back the first CSI report;
feeding back a part of content of the first CSI report;
indicating, in the second CSI report, whether to feed back the first CSI report; or
indicating, in the second CSI report, whether to feed back a part of content of the first CSI report.

In an optional implementation, the sending module 702 is further configured to send twelfth network signaling to the terminal, where the twelfth network signaling indicates that PMI associated with the second CSI report is calculated by using a target symbol associated with a CSI reference resource associated with the second CSI report, where the second CSI report includes multi-transmission and reception point (MTRP) CSI.

In an optional implementation, the sending module 702 is further configured to send thirteenth network signaling to the terminal, where the thirteenth network signaling indicates one of the following:
obtaining, by the terminal, the second CSI report based on a target feedback of the at least one first CSI report associated with the second CSI report, where the target feedback includes one of the following that are not later than the CSI reference resource associated with the second CSI report: a latest feedback, any feedback, and one feedback specified in a protocol; and
skipping obtaining, by the terminal, the second CSI report based on any feedback of the at least one first CSI report associated with the second CSI report.

In an optional implementation, the sending module 702 is further configured to perform at least one of the following:
sending fourteenth network signaling to the terminal, where the fourteenth network signaling indicates the terminal to obtain the second CSI report based on a target value, and the target value includes one of the following: a frequency offset value, a delay value, an offset value of a frequency offset, and a delay offset; or
sending fifteenth network signaling to the terminal, where the fifteenth network signaling indicates to obtain the second CSI report by referring to all or a part of the target information of the at least one first CSI report.

The apparatus for configuring a channel state information report provided in this embodiment of this application can implement the processes implemented in the method embodiment in FIG. 5, and achieve a same technical effect. To avoid repetition, details are not described herein again.

As shown in FIG. 8, an embodiment of this application further provides a communication device 800, including a processor 801 and a memory 802. The memory 802 stores a program or an instruction that can be run on the processor 801. For example, when the communication device 800 is a terminal, the program or the instruction is executed by the processor 801 to implement the steps of the embodiment of the method for obtaining a channel state information report, and a same technical effect can be achieved. When the communication device 800 is a network side device, the program or the instruction is executed by the processor 801 to implement the steps of the embodiment of the method for configuring a channel state information report, and a same technical effect can be achieved. To avoid repetition, details are not described herein again.

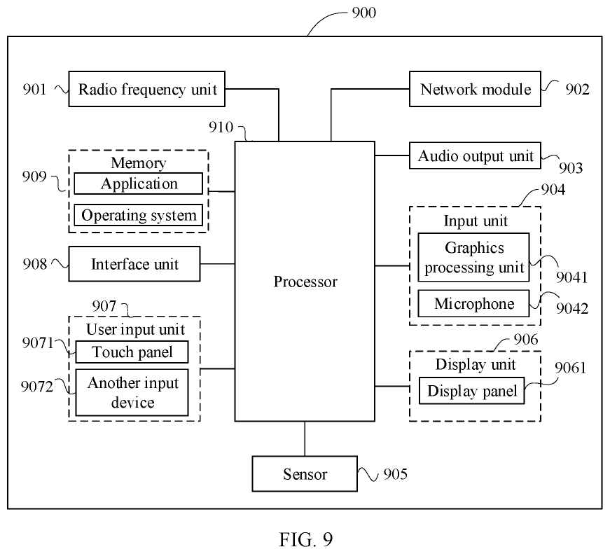

An embodiment of this application further provides a terminal, including a processor and a communication interface. The communication interface is coupled to the processor, and the processor is configured to run a program or an instruction to implement the steps of the method embodiment shown in FIG. 2. The terminal embodiment is corresponding to the method embodiment on the terminal side, each implementation process and implementation of the method embodiment can be applied to the terminal embodiment, and a same technical effect can be achieved. Specifically, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the terminal 900 may further include a power supply (such as a battery) that supplies power to each component. The power supply may be logically connected to the processor 910 through a power management system, to implement functions such as charging and discharging management, and power consumption management by using the power management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may include a volatile memory or a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, alternatively, the modem processor may not be integrated into the processor 910.

The processor 910 is configured to:
determine that a first CSI report to be fed back currently includes target information, where the target information includes at least one of the following: delay information or frequency offset information; and
obtain the target information based on a reference signal associated with the first CSI report.

It may be understood that for the implementation process of each implementation given in this embodiment, refer to the related description of the method embodiment 200, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 5. This network side device embodiment is corresponding to the foregoing method embodiment of the network side device. Each implementation process and implementation of the foregoing method embodiment may be applicable to this network side device embodiment, and a same technical effect can be achieved.

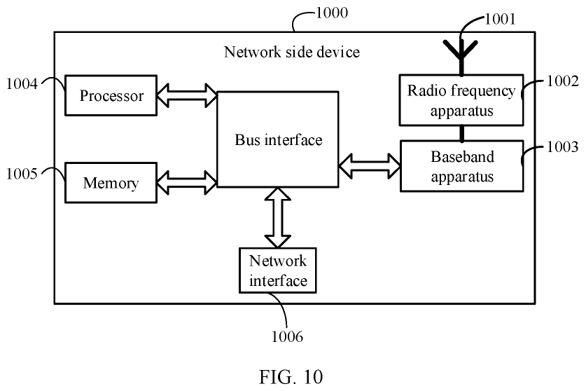

Specifically, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information through the antenna 1001.

In the foregoing embodiment, the method performed by the network side device may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 by using a bus interface, to invoke a program in the memory 1005 to perform the operations of the network device shown in the foregoing method embodiment.

The network side device may further include a network interface 1006, and the interface is, for example, a common public radio interface (CPRI).

Specifically, the network side device 1000 in this embodiment of this application further includes an instruction or a program that is stored in the memory 1005 and that can be run on the processor 1004. The processor 1004 invokes the instruction or the program in the memory 1005 to perform the method performed by the modules shown in FIG. 7, and a same technical effect is achieved. To avoid repetition, details are not described herein again.

An embodiment of this application further provides a readable storage medium. The readable storage medium stores a program or an instruction, and the program or the instruction is executed by a processor to implement the processes of the embodiment of the method for obtaining a channel state information report, or implement the processes of the embodiment of the method for configuring a channel state information report, with a same technical effect achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the embodiment of the method for obtaining a channel state information report, or implement the processes of the embodiment of the method for configuring a channel state information report, with a same technical effect achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the embodiment of the method for obtaining a channel state information report, or implement the processes of the embodiment of the method for configuring a channel state information report, with a same technical effect achieved. To avoid repetition, details are not described herein again.

An embodiment of this application further provides a system for obtaining a channel state information report, including a terminal and a network side device. The terminal may be configured to perform the processes of the embodiment of the method for obtaining a channel state information report, and the network side device may be configured to perform the processes of the embodiment of the method for configuring a channel state information report.

In the embodiments of this application, the terminal determines that the first CSI report to be fed back currently includes target information, where the target information includes at least one of the following: delay information or frequency offset information, and then obtains the target information based on a reference signal associated with the first CSI report. Therefore, the first CSI report obtained by the terminal may include the delay information or the frequency offset information, so that when feeding back the CSI report, the terminal may feed back the delay information or the frequency offset information. In this way, the network side device may perform time synchronization or timing synchronization with the terminal based on the delay information, or perform frequency alignment with the terminal based on the frequency offset information.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. A method for obtaining a channel state information report, comprising:
determining, by a terminal, that a first channel state information (CSI) report to be fed back currently comprises target information, wherein the target information comprises delay information and frequency offset information; and
obtaining, by the terminal, the target information based on a reference signal associated with the first CSI report.

2. The method according to claim 1, wherein the determining, by the terminal, that the first CSI report to be fed back currently comprises target information comprises:
determining, by the terminal based on first network signaling sent by a network side device, that the first CSI report comprises the target information.

3. The method according to claim 1, wherein before the obtaining, by the terminal, the target information based on a reference signal associated with the first CSI report, the method further comprises at least one of the following:
determining, by the terminal based on second network signaling sent by a network side device, at least one first reference signal or at least one first reference signal set associated with the delay information, wherein the first reference signal set comprises at least one first reference signal;
determining, by the terminal based on third network signaling sent by a network side device, at least one second reference signal or at least one second reference signal set associated with the frequency offset information, wherein the second reference signal set comprises at least one second reference signal;
determining, by the terminal based on fourth network signaling sent by a network side device, an accuracy of the delay information;
determining, by the terminal based on fifth network signaling sent by a network side device, an accuracy of the frequency offset information;
determining, by the terminal based on sixth network signaling sent by a network side device, a quantity of pieces of delay information comprised in the first CSI report;
determining, by the terminal based on seventh network signaling sent by a network side device, a maximum quantity of pieces of delay information comprised in the first CSI report;
determining, by the terminal based on eighth network signaling sent by a network side device, a quantity of pieces of frequency offset information comprised in the first CSI report; or
determining, by the terminal based on ninth network signaling sent by a network side device, a maximum quantity of pieces of frequency offset information comprised in the first CSI report.

4. The method according to claim 1, wherein in a case that the first CSI report comprises the frequency offset information, the frequency offset information comprised in the first CSI report comprises one of the following:
a frequency offset associated with each second reference signal set; or
an offset value of a frequency offset of each second reference signal set relative to a frequency offset associated with a benchmark reference signal set.

5. The method according to claim 4, wherein the benchmark reference signal set is one of a plurality of second reference signal sets associated with the first CSI report, or one of a plurality of second reference signal sets selected by the terminal.

6. The method according to claim 4, wherein an offset value of the frequency offset of the benchmark reference signal set is set to 0.

7. The method according to claim 4, wherein, before the obtaining, by the terminal, the target information based on a reference signal associated with the first CSI report, the method further comprises:
determining, by the terminal based on tenth network signaling sent by the network side device, that the frequency offset information comprises the frequency offset or the offset value of the frequency offset.

8. The method according to claim 1, wherein a quantity of CSI processing units (CPU) associated with the first CSI report is related to at least one of the following:
a quantity of reference signal sets associated with the first CSI report; or
the target information comprised in the first CSI report.

9. The method according to claim 1, wherein the method further comprises:
indicating, by the terminal, a reference signal set referenced by the delay information in the first CSI report; and indicating, by the terminal, a reference signal set referenced by the frequency offset information in the first CSI report.

10. A method for configuring a channel state information report, comprising:
sending, by a network side device, first network signaling to a terminal, wherein the first network signaling is used to configure a first channel state information (CSI) report fed back by the terminal to comprise target information, and the target information comprises delay information and frequency offset information.

11. The method according to claim 10, wherein the method further comprises at least one of the following:
sending, by the network side device, second network signaling to the terminal, wherein the second network signaling indicates at least one first reference signal or at least one first reference signal set associated with the delay information, and the first reference signal set comprises at least one first reference signal;
sending, by the network side device, third network signaling to the terminal, wherein the third network signaling indicates at least one second reference signal or at least one second reference signal set associated with the frequency offset information, and the second reference signal set comprises at least one second reference signal;
sending, by the network side device, fourth network signaling to the terminal, wherein the fourth network signaling indicates an accuracy of the delay information;
sending, by the network side device, fifth network signaling to the terminal, wherein the fifth network signaling indicates an accuracy of the frequency offset information;
sending, by the network side device, sixth network signaling to the terminal, wherein the sixth network signaling indicates a quantity of pieces of delay information comprised in the first CSI report;
sending, by the network side device, seventh network signaling to the terminal, wherein the seventh network signaling indicates a maximum quantity of pieces of delay information comprised in the first CSI report;
sending, by the network side device, eighth network signaling to the terminal, wherein the eighth network signaling indicates a quantity of pieces of frequency offset information comprised in the first CSI report; or
sending, by the network side device, ninth network signaling to the terminal, wherein the ninth network signaling indicates a maximum quantity of pieces of frequency offset information comprised in the first CSI report.

12. The method according to claim 10, wherein in a case that the first CSI report comprises the frequency offset information, the frequency offset information comprised in the first CSI report comprises one of the following:
a frequency offset associated with each second reference signal set; or
an offset value of a frequency offset of each second reference signal set relative to a frequency offset associated with a benchmark reference signal set.

13. The method according to claim 12, wherein the benchmark reference signal set is one of a plurality of second reference signal sets associated with the first CSI report, or one of a plurality of second reference signal sets selected by the terminal.

14. The method according to claim 12, an offset value of the frequency offset of the benchmark reference signal set is set to 0.

15. The method according to claim 12, wherein the method further comprises:
sending, by the network side device, tenth network signaling to the terminal, wherein the tenth network signaling indicates that the frequency offset information comprises the frequency offset or the offset value of the frequency offset.

16. The method according to claim 10, wherein a quantity of CSI processing units (CPU) associated with the first CSI report is related to at least one of the following:
a quantity of reference signal sets associated with the first CSI report; or
the target information comprised in the first CSI report.

17. The method according to claim 10, wherein a reference signal set referenced by the delay information is indicated in the first CSI report, and a reference signal set referenced by the frequency offset information is indicated in the first CSI report.

18. A terminal, comprising a processor implemented in hardware and a memory, wherein the memory stores a program or an instruction executable by the processor, and the program or the instruction is executed by the processor to:
determine that a first channel state information (CSI) report to be fed back currently comprises target information, wherein the target information comprises delay information and frequency offset information; and
obtain the target information based on a reference signal associated with the first CSI report.

19. A network side device, comprising a processor implemented in hardware and a memory, wherein the memory stores a program or an instruction executable by the processor, and the program or the instruction is executed by the processor to implement the method for configuring a channel state information report according to claim 10.

20. A non-transitory computer-readable storage medium having a program or an instruction stored thereon that, when executed by a processor implemented in hardware, implements the method for obtaining a channel state information report according to claim 1.
